(19) United States
(12) Patent Application Publication
(10) Pub. No.: US 2013/0180243 A1
(43) Pub. Date: Jul. 18, 2013

(54) METHODS OF AUGMENTATION AND HEAT COLLECTING CONDUIT SYSTEM FOR MECHANICAL LEVERAGE AND AIR CONDITIONING

(71) Applicant: Arthur F. Hurtado, Riverside, CA (US)

(72) Inventor: Arthur F. Hurtado, Riverside, CA (US)

(21) Appl. No.: 13/552,599

(22) Filed: Jul. 18, 2012

Related U.S. Application Data
(63) Continuation-in-part of application No. 13/530,097, filed on Jun. 21, 2012.
Application No. 13/530,097 is a continuation-in-part of application No. 13/011,729, filed on Jan. 21, 2011.
(60) Provisional application No. 61/336,465, filed on Jan. 25, 2010.
(60) Provisional application No. 61/572,435, filed on Jul. 18, 2011.
(60) Provisional application No. 61/630,122, filed on Dec. 6, 2011.

(51) Int. Cl. F03G 7/04

(52) U.S. Cl. CPC F03G 7/04
USPC 60/641.6

(57) ABSTRACT

A mechanical leverage system comprising a first piston and cylinder assembly and a second piston and cylinder assembly and a first, a second and a third chamber, wherein, the first chamber comprises a first evaporator for absorbing heat from its surroundings so as to generate a gas-phase from a liquid-phase of the fluid, the second chamber comprises a second evaporator for absorbing heat from its surroundings so as to generate a gas-phase from a liquid-phase of the fluid and the third chamber comprises a condenser for expelling heat to its surroundings so as to convert a gas-phase of the fluid to a liquid-phase; wherein the second piston's cylinder is in controlled fluid communication with the second chamber and the third chamber such that the second piston acts as an expander for converting the thermal energy of the gas-phase fluid generated by the second evaporator into mechanical energy.

### CROSS-REFERENCE TO RELATED APPLICATIONS

This application is a continuation-in-part and claims the benefit of the now pending U.S. Non-provisional application Ser. No. 13/530,097 filed Jun. 21, 2012, which is a continuation in part of U.S. Non-provisional application Ser. No. 13/011,729 filed Jan. 21, 2011, which in turn claims the benefit of U.S. Provisional Application No. 61/336,465, filed Jan. 25, 2010. This application also claims the benefit of U.S. Provisional Application No. 61/572,435, filed Jul. 18, 2011 and U.S. Provisional Application No. 61/630,122, filed Dec. 6, 2011. All prior filed applications mentioned above are hereby incorporated by reference to the extent that they are not conflicting with the present application.

### BACKGROUND OF THE INVENTION

1. Field of the Invention

The present invention relates generally to air conditioning systems and particularly to air conditioning systems configured to use mechanical leverage in order to save or produce energy.

2. Description of the Related Art

Two-chamber conventional air conditioning systems using an evaporator, a condenser and a compressor to move refrigerant vapors from the evaporator to the condenser are well known. The problem is that these systems are high consumers of electrical energy, and therefore, economically less and less attractive as energy becomes more and more scarce and expensive.

Attempts were also made to design systems that would capture the heat in the attic or other forms of heat energy for the purpose of using it in air conditioning applications, pool heating, refrigeration applications and electrical energy generation. The problem with these systems is that they are difficult and expensive to build and overall inefficient.

Therefore, a new, inexpensive, versatile and more efficient energy saving system is needed to take advantage of the abundantly and freely available ambient heat energy, such as heat from the attic, and/or other forms of heat energy such as the renewable solar energy.

The problems and the associated solutions presented in this section could be or could have been pursued, but they are not necessarily approaches that have been previously conceived or pursued. Therefore, unless otherwise indicated, it should not be assumed that any of the approaches presented in this section qualify as prior art merely by virtue of their presence in this section of the application.

### BRIEF SUMMARY OF THE INVENTION

In one embodiment, a mechanical leverage system using refrigerants in conjunction with temperature differences found in the environment is utilized for air conditioning. The mechanical leverage system provides a means for altering boiling point temperatures of refrigerants in which the system is enabled to absorb and expel heat within the temperature differentials found in the environment.

Suitable heat donors and receivers for this process to proceed are essential. This may be economically obtained through heat differences occurring naturally in our environment. Environmental temperature differences are usually ample in supply. For example, temperatures of 120 degrees F. may be readily obtained by utilizing heat from attic spaces and heat collecting devices such as solar panels and parabolic mirrors. Conversely, cooler ambient air temperatures are also readily obtainable. Hence, an advantage of the system is the ability to use ambient heat and/or solar energy collected from the environment to power an air conditioning installation and, thus, to save energy.

In another embodiment, a mechanical leverage system using refrigerants in conjunction with temperature differences found in the environment is used for collecting heat energy from the environment for the purpose of generating electricity. Thus, an advantage of the system is the ability to convert plentifully available ambient heat energy and/or solar energy into electrical energy.

In another embodiment, input of energy may be applied to augment the system, when necessary to supplement the amount of heat energy collected from the environment.

The above embodiments and advantages, as well as other embodiments and advantages, will become apparent from the ensuing description and accompanying drawings.

### BRIEF DESCRIPTION OF THE DRAWINGS

For exemplification purposes, and not for limitation purposes, embodiments of the invention are illustrated in the figures of the accompanying drawings, in which:

FIG. 1 illustrates a diagrammatic view of an air conditioning system, using mechanical leverage and refrigerant, according to one embodiment.

FIG. 2 illustrates a diagrammatic view of an air conditioning system, using mechanical leverage and refrigerant, according to another embodiment.

FIG. 3 illustrates a diagrammatic view of the same air conditioning system, using mechanical leverage and refrigerant, as in FIG. 2, except that, the valves that are closed in FIG. 2 are open in FIG. 3, and vice versa.

FIG. 4 illustrates a diagrammatic view of an air conditioning system, using mechanical leverage and refrigerant, according to another embodiment. The elements of the system are the same as those of the system depicted in FIG. 2, except that the temperature and the pressure in second chamber 412 are smaller, while the area of second piston 422 is greater.

FIG. 5 illustrates a diagrammatic view of a system as in FIG. 2 without first chamber, first piston, and their respective refrigerant returns, according to another embodiment.

FIG. 6 illustrates a diagrammatic view of the same system as in FIG. 5, except that, the valves that are closed in FIG. 5 are open in FIG. 6, and vice versa.

FIG. 7 depicts the same system as in FIG. 2, except that a fourth chamber and an extra pump were added.

FIG. 8 depicts the same system as in FIG. 7 except that the valves that are closed in FIG. 7 are open in FIG. 8, and vice versa.

FIG. 9 depicts the same system as in FIG. 1 except that a partition and an extra pump were added.

FIG. 10 is a schematic view of a mechanical leverage system using turbines instead of pistons.

FIG. 11 depicts the mechanical leverage system from FIG. 10, augmented with a motor E.

FIG. 12 is an illustration of the mechanical leverage system adapted to generate electricity using a generator G.

FIG. 13 is an illustration of the system using mechanical leveraging to generate compressed air.

FIG. 14 an illustration of the mechanical leverage system adapted to function as a heat pump.

FIG. 15 shows, according to another embodiment, a schematic view of a reciprocal piston based mechanical leverage system in which the refrigerant vapor from first chamber is transferred to the third chamber and pistons are moving to the right.

FIG. 16 shows the system in FIG. 15 when pistons are moving to the left.

FIG. 17 shows the system in FIG. 15 augmented with a compressor placed between second chamber and second piston, according to another embodiment.

FIG. 18 shows the system in FIG. 15 augmented with a compressor placed between first chamber and first piston, according to another embodiment.

FIG. 19 shows the system in FIG. 15 augmented with a compressor placed between first piston and third chamber, according to another embodiment.

FIG. 20 shows the system in FIG. 15 augmented with a mechanical device engaged onto the shaft between the two pistons, according to another embodiment.

FIG. 21 depicts work in graphic form as the area of a rectangle determined by the product of pressure and volume.

FIG. 22 shows in a graphic form the work when energy augmentation is used.

FIG. 23 shows the partial top-side perspective view of a house roof, which was modified to incorporate a heat collecting system, according to another embodiment.

FIG. 24a depicts the bottom-front perspective view of the house roof from FIG. 23.

FIG. 24b depicts the house roof from FIG. 24a further including air conduits.

FIG. 25a depicts the front view of the house roof from FIG. 24b further including additional air conduits and an evaporator box.

FIG. 25b is a perspective view of the evaporator box from FIG. 25a.

FIG. 25c depicts the bottom-back perspective view of the house roof from FIG. 25a.

FIG. 25d depicts the partial side perspective view of the house roof from FIG. 25c, having the roof sheeting removed for illustration purposes.

FIG. 25e depicts the perspective view of the return conduit 2502a from FIG. 25d.

### DETAILED DESCRIPTION OF THE PREFERRED EMBODIMENTS

What follows is a detailed description of the preferred embodiments of the invention in which the invention may be practiced. Reference will be made to the attached drawings, and the information included in the drawings is part of this detailed description. The specific preferred embodiments of the invention, which will be described herein, are presented for exemplification purposes, and not for limitation purposes. It should be understood that structural and/or logical modifications could be made by someone of ordinary skills in the art without departing from the scope of the present invention. Therefore, the scope of the present invention is defined by the accompanying claims and their equivalents.

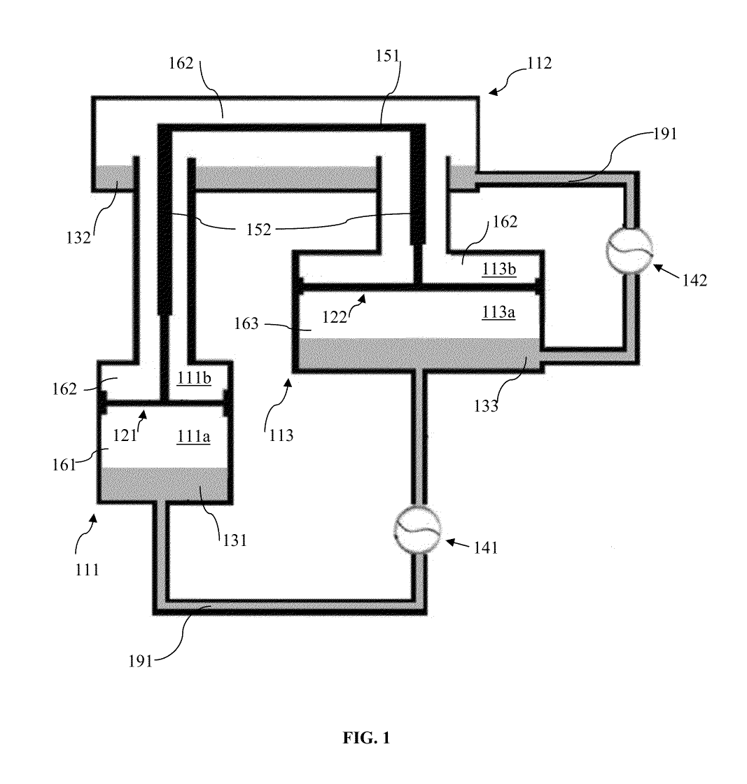

FIG. 1 illustrates a diagrammatic view of an air conditioning system, using mechanical leverage and refrigerant, according to one embodiment. In general, refrigerants that are suitable for air conditioning consist of refrigerants having substantial latent heat of vaporizations and high vapor pressures with boiling points within the parameters of environmental temperatures. It is to be noted that, for exemplification purposes, in the systems depicted in FIG. 1 and in the subsequent figures the refrigerant used is ammonia (NH3).

The system in FIG. 1 comprises first chamber 111 containing first piston 121, which is configured to have the capability of moving hermetically inside first chamber 111. Hence, first chamber 111 is in effect also a cylinder for first piston 121. Thus, at various times in the system's cycle, first piston 121 effectively divides first chamber 111 into two sub-chambers 111a (first sub-chamber) and 111b (second sub-chamber). Similarly, second piston 122 divides third chamber 113 into sub-chambers 113a (third sub-chamber) and 113b (fourth sub-chamber). Sub-chamber 111a contains ammonia liquid 131 and ammonia vapor 161 at a pressure of 6.15 bars. Sub-chamber 111b contains ammonia vapor 162 at a pressure of 20.33 bars. Second Chamber 112 contains ammonia liquid 132 and ammonia vapor 162 at a pressure of 20.33 bars. Sub-chamber 113b contains ammonia vapor 162 at a pressure of 20.33 bars. Sub-chamber 113a contains ammonia liquid 133 and ammonia vapor 163 at a pressure of 15.54 bars.

It should be understood that the vertical configuration of the two pistons in FIG. 1 is used for illustration purposes only. Other configurations may be used (e.g. horizontal or inclined configurations) without departing from the scope of the invention.

Second sub-chamber 111b communicates with second chamber 112, which contains ammonia vapor 162 at a pressure of 20.33 bars. Next, second chamber 112 communicates with fourth sub-chamber 113b. Finally, third sub-chamber 113a, contains liquid ammonia 133 and ammonia vapors at a pressure of 15.54 bars, and it is configured to communicate controllably with first sub-chamber 111a and second chamber 112, with the aid of counter resistance 141 and pump 142, respectively. The counter resistance 141 may be a release valve, which may be used to release as needed some of the liquid ammonia 133 from third sub-chamber 113a into first sub-chamber 111a. The pump 142 may be used to pump as needed some of the liquid ammonia 133 from third sub-chamber 113a into second chamber 112.

First piston 121 and second piston 122 are communicated by a hydraulic system, comprising hydraulic members 152 and hydraulic hose 151, and are counter balanced against each other. The non-compressible fluid of the hydraulic system transfers pressure from one piston to the other making the actions of the pistons responsive to one another. Thus, it is ensured that, when the equilibrium is disturbed, the distance traveled by first piston 121 is equaled with the distance traveled by second piston 122. The pistons are mechanized by a push/ pull action in that the energy from vaporization will push the first piston 121 and, conversely, the energy from condensation will pull the second piston 122.

The balancing of the two pistons is achieved by using a piston system, where second piston 122 has a larger surface area than first piston 121 in order to compensate for pressure differences. It is well established that:

(Difference in pressure 1)×Area 1=(Difference in pressure 2)×Area 2

From the above formula it may be deducted that in a leverage system, if the difference in vapor pressure acting on the first piston is larger than the difference of pressure acting on the second piston, then the surface area of the first piston is smaller than the surface area of the second piston. Furthermore, since the vapor pressure of refrigerants are proportional to temperature, the temperature differential associated with the first piston having the smaller surface area is greater than the temperature differential associated with the second piston having the larger surface area.

Again, for exemplification purposes, let's assume that first sub-chamber 111a contains liquid ammonia 131 at a pressure of 6.15 bars. The boiling point of ammonia at this pressure is 50 degrees Fahrenheit (F.). Thus, at the temperature of 50 degrees F. or greater, the liquid ammonia 131 will boil filling with ammonia vapors 161 all available space delimited by the walls of first sub-chamber 111a and first piston 121. The second chamber 112 contains liquid ammonia 132 at a pressure of 20.33 bars. The boiling point of ammonia at this pressure is 122 degrees F. Thus, at the temperature of 122 degrees F. or greater, the liquid ammonia 132 will boil filling with ammonia vapors 162 all available space delimited by first piston 121, the walls of second sub-chamber 111b, the walls of second chamber 112, the walls of fourth sub-chamber 113b, and second piston 122. The third sub-chamber 113a contains liquid ammonia 133 and ammonia vapors 163 at a pressure of 15.54 bars. The boiling point of ammonia at this pressure is 104 degrees F. Thus, at the temperature of 104 degrees F. or lower, the ammonia vapors 163 in third sub-chamber 113a will condense joining the liquid ammonia 133.

To summarize, first sub-chamber 111a contains ammonia at a pressure of 6.15 bars and a temperature of 50 degrees F. At these parameters, one kilogram (kg) of ammonia vapor 161 occupies a volume of 0.2056 cubic meters. Second chamber 112 contains ammonia at a pressure of 20.33 bars and a temperature of 122 degrees F. At these parameters, one kilogram of ammonia vapor 162 occupies a volume of 0.0635 cubic meters. Finally, third sub-chamber 113a contains ammonia at a pressure of 15.54 bars and a temperature of 104 degrees F. At these parameters, one kilogram (kg) of ammonia vapor 163 occupies a volume of 0.0833 cubic meters.

At equilibrium the force exerted on piston 121 equals the force exerted on piston 122:

Force 1=Force 2
If F=P×A, or, F=ΔP×A, then:

(P2−P1)×A1=(P2−P3)×A2; (Eq. 1);
P1 is the pressure (6.15 bars) in first sub-chamber 111a; P2 is the pressure (20.33 bars) in second sub-chamber 111b, second chamber 112 and fourth sub-chamber 113b; P3 is the pressure (15.54 bars) in third sub-chamber 113a; A1 is the surface area of piston 121; A2 is the surface area of piston 122.
Then, if, for example, A1=1 sq. meter, then
(20.33−6.15) bars×1 sq. meter=(20.33−15.54) bars×A2, or:
14.18=4.79 (A2)
It results that, A2=2.96 sq. meters.

Since both pistons are interconnected, if first piston 121 travels 1 meter then second piston 122 also travels 1 meter. This means that:

Work 1=Work 2, or

P1×V1=P2×V2

### (Eq. 2), or

P1×A1×Si=P2×A2×S2; (Eq. 3);
S1=S2=1 meter; then,
14.18 bars×1 sq. meter×1 meter=4.79 bars×2.96 sq. meters×1 meter, or 14.18 bars×cubic. meter=14.18 bars×cubic.meter

The ammonia in first sub-chamber 111a will boil and absorb heat from the room where it is placed. At 6.15 bars of vapor pressure, the temperature of the ammonia in first sub-chamber 111a is 50 degrees F. The ammonia at this temperature will adequately remove heat from a room where the temperature is greater than 50 degrees F. (for example, 75 degrees F.). As heat is removed from the room into first sub-chamber 111a, the ammonia within it will boil and will tend to equilibrate to the point of saturation. The resulting increase in ammonia vapor pressure (P1) in first sub-chamber 111a will translate into a pushing force exerted on first piston 121.

The second chamber 112 contains ammonia at a pressure of 20.33 bars (P2). Ammonia at this pressure requires a temperature of 122 degrees F. to boil. Heat may be acquired from ambient temperature of the attic, where second chamber 112 may be placed, and/or, from other sources, such as solar panels or reflectors, if needed. The boiling of the ammonia in second chamber 112 will result in an increase of the vapor pressure (P2), which will translate into a pushing force exerted on the first piston 121 and the second piston 122. The force exerted on second piston 122 is greater than the force exerted on first piston 121 due to the surface area of second piston 122 being greater than that of first piston 121. Hence, when, in second chamber 112, the pressure P2, which at system equilibrium is 20.33 bars, increases, the two pistons 121, 122 move clockwise (when looking at the exemplary system depicted in FIG. 1).

Third sub-chamber 113a contains ammonia at a pressure of 15.54 bars (P3) and a temperature of 104 degrees F. The ammonia vapor will condense by loosing heat to the cooler outside ambient air having a temperature of, for example, 95 degrees F. The condensation of the ammonia vapor in third sub-chamber 113a results in a decrease of vapor pressure, and thus, will have a pulling force effect exerted on second piston 122.

As explained later, the pressure/temperature difference between chamber 2 and third sub-chamber chamber 113a may be narrower with the use of the leverage system. The narrowing of this pressure/temperature difference makes it possible for the system to absorb heat and expel heat within the temperature ranges found in the environment. Thus, enabling the refrigerant in second chamber 112 to boil, and subsequently condense in sub-chamber 113a, at narrower pressure/temperature differences between attic and outside ambient air. This is an important advantage as the environmental temperatures are invariably uncontrollable. Hence, it becomes necessary to configure the leverage system to work within these parameters.

First sub-chamber 111a acts as an evaporator and third sub-chamber 113a acts as a condenser. Again, the three interconnected chambers may be placed at different locations. First chamber 111 may be placed inside the space to be cooled, second chamber 112 may be placed in the attic, and third chamber 113 may be place outside. The forces exerted by the actions of the ammonia vapors on piston 121 and piston 122 are transferred between the two pistons by hydraulic pressure hose(s) 151 and the ammonia is transferred among the various chambers by tubing 191.

Each of the three chambers will tend to reach equilibrium with one another, as changes in temperature occur. Either by the process of boiling or condensing, each chamber will strive to maintain vapor pressures corresponding to their respective temperatures and saturation levels. The boiling and condensing of the refrigerant creates a pushing and pulling force on the pistons and drives the system forward.

The specific volume of the ammonia vapors in first sub-chamber 111a is 0.2056 cubic meter/kg and the specific volume of vapor in second chamber 112 is 0.0635 cubic meter/kg. The specific volume of vapor from sub-chamber 111-a to second chamber 112 is decreased by a factor of (0.2056/0.0635) or 3.227. This is equivalent to saying that the density of the ammonia vapors in second chamber 112 is 3.227 times greater than the density of the ammonia vapors in first sub-chamber 111a. The area of second piston 122 is 2.96 greater than the area of first piston 121. Therefore, second piston 122 displaces (3.227×2.96) or 9.5 times more vapor than first piston 121. The production of the required additional vapor takes place in second chamber 112. As discussed, most of the vapor production and heat absorption takes place in second chamber 112. This makes up the greatest portion of the required energy to power the system.

Fortunately, this additional energy, in the form of heat, may be derived from unwanted heat from spaces such as the attic. Higher temperatures may also be readily obtained by utilizing heating devices such as solar panels and parabolic mirrors. Solar heat collectors such as venting canal systems may also be used. Venting canals are made up of insulated panels affixed to the bottom portion of the rafters of a pitched roof. This results in a longitudinal compartment bounded by the adjacent rafters on each side and by the sheathing of the roof on the top and the insulated panels on the bottom. The longitudinal compartment or canal confines the air space below the roofline and concentrates the heat to higher temperatures. The heated air rises, within the canals, to the apex of the roof where the heat is absorbed by the boiling of the refrigerant in second chamber 112.

Second chamber 112 may be in the form of a long tube, containing refrigerant, and may be placed along the apex or ridgeline of the roof, thus, absorbing heat from the attic and/or, for example, venting canals. Hence, the boiling of the refrigerant in the tube is caused by the heat from the attic and/or the venting canals. Thus, this unwanted and abundantly available heat becomes the fuel that powers the cooling system.

There is a two-fold advantage to this process. First, the more heat is absorbed by the refrigerant in second chamber 112, the more heat is also absorbed in first chamber 111, namely its 111a first sub-chamber, and hence, more cooling occurs in the living area. This is because, the higher the temperature in second chamber 112, the greater is the pushing and “pulling” (because of the hydraulic link) effect on second piston 122 and first piston 121, respectively, exercised by the refrigerant gases from second chamber 112. This translates in expanded volume, and thus, lower pressure and lower temperature in first sub-chamber 111a, which means that more heat will be absorbed from the living area. Secondly, the heat that would normally accumulate in the attic and ultimately penetrate the living spaces of a house is diverted and absorbed by second chamber 112 of the cooling system. Consequently, this absorbed heat never has the opportunity to penetrate and heat the inside of the house.

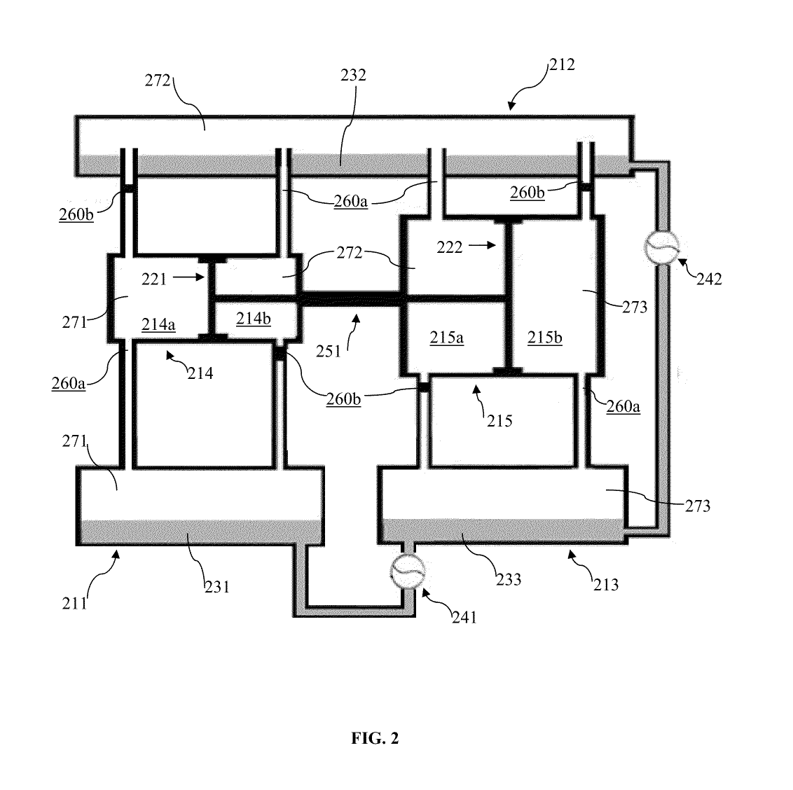

FIG. 2 illustrates a diagrammatic view of an air conditioning system, using mechanical leverage and refrigerant, according to another embodiment. The pistons and chambers from FIG. 1 are rearranged to arrive at the illustrated configuration of a pumping system that pumps vapor from first chamber 211 into second chamber 212 and ultimately into third chamber 213.

When the system is at equilibrium the parameters of temperature and pressure in the three chambers are maintained and stabilized as earlier described (first chamber 211 contains liquid ammonia 231 and ammonia vapor 271 at a pressure of 6.15 bars (P1) and a temperature of 50 degrees F.; second chamber 212 contains liquid ammonia 232 and ammonia vapor 272 at a pressure of 20.33 bars (P2) and a temperature of 122 degrees F.; third chamber 213 contains liquid ammonia 233 and ammonia vapor 273 at a pressure of 15.54 bars (P3) and a temperature of 104 degrees F.). However, the equilibrium state of the chambers become disturbed as the refrigerant boils in chambers 211 and 212 and condenses in chamber 213. The resultant change of vapor pressure in the chambers pumps the vapor through the system.

Pistons 221 and 222 are adjoined and move together as a unit, pushing the vapor through the system. The connector 251 between the two pistons 221, 222 may be a hydraulic system or link, which may comprise hydraulic member(s), such as a hydraulic piston, and hydraulic hose(s). When the four valves 260a are open and the four valves 260b are closed, as shown in FIG. 2, the two pistons move towards the right. It should be noted that, when the four valves 260a are open and the four valves 260b are closed, the pressure (P1) and the temperature of the refrigerant vapor 271 are the same in the left side 214a (i.e., first sub-chamber) of first cylinder 214 as in first chamber 211; the pressure (P2) and the temperature of the vapor 272 are also the same in the right side 214b (i.e., second sub-chamber) of first cylinder 214, and the left side 215a (i.e., third sub-chamber) of second cylinder 215, as in second chamber 212; finally, the pressure (P3) and the temperature of the vapor 273 are the same in the right side 215b (i.e., fourth sub-chamber) of second cylinder 215 as in third chamber 213. It should be understood that the horizontal configuration of the two pistons in FIG. 2 (and in the subsequent figures), and thus, the associated nomenclature (left side, right side, etc) are used for illustration purposes only. Other configurations may be used (e.g. vertical or inclined configurations) without departing from the scope of the invention.

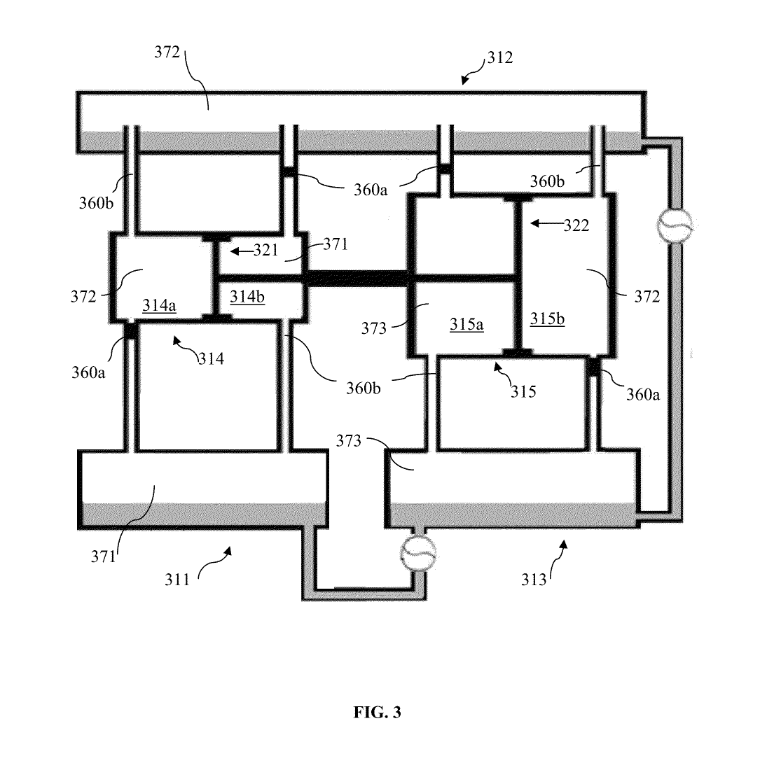

When the two pistons 221, 222 reach their end point to the right in the respective cylinders 214, 215, an electronic or a mechanical switch for example, close the four valves 260a and open the four valves 260b (as illustrated in FIG. 3 where the same valves are labeled as 360a and 360b, respectively). The polarity of pressure acting upon the system becomes reversed and the two pistons, 321 and 322 (FIG. 3), move to the left. The pressure (P1) and the temperature of the refrigerant vapor 371 (FIG. 3) are the same in the right side 314b (i.e., second sub-chamber) of first cylinder 314 as in first chamber 311; the pressure (P2) and the temperature of the vapor 372 are also the same in the left side 314a (i.e., first sub-chamber) of first cylinder 314, and the right side 315b (i.e., fourth sub-chamber) of second cylinder 315, as in second chamber 312; finally, the pressure (P3) and the temperature of the vapor 373 are the same in the left side 315a (i.e., third sub-chamber) of second cylinder 315 as in third chamber 313.

The cycle repeats when the polarity of pressure reverses again, when the pistons 321, 322 reach the end point to the left. The vapor flows continuously through the system as pistons 321 and 322 oscillate back and forth.

The condensed ammonia liquid in third chamber 213 must be recycled to first chamber 211 and second chamber 212 in proportion to their original amounts. Input of work is required at turbine 242 to pump ammonia liquid from third chamber 213 into second chamber 212, against a pressure difference of 4.79 bars (P2−P3). However, work is gained at turbine 241 as 9.39 bars (P3−P1) of ammonia liquid pressure is released from third chamber 213 into first chamber 211. A counter resistance of 9.39 bars at turbine 241 is necessary to keep the system in equilibrium.

It should be noted that the volume of chambers 211, 212 and 213 are substantially larger than the volume of cylinders 214, 215 so as to create minimal change in pressure in chambers 211, 212 and 213 as the ammonia vapor ingresses and egresses via the opening of valves 260a and 260b.

If the volume displaced by each stroke of piston 221 equals 1 cubic meter then the volume of each stroke displaced by piston 222 is 2.97 cubic meters. This is because, as it was explained earlier when describing FIG. 1, the surface area of piston 222 is 2.97 times the surface area of piston 221 in order to achieve equilibrium at the given temperature and pressure levels. In addition, as also explained earlier, because of the manner in which pistons 221, 222 are connected to each other, they travel the same distances.

As stated earlier, the specific volume of the ammonia in chamber 211 is 0.2056 cubic meter/kg, which means that its density is 4.86 kg/cubic meter. In chamber 212 the specific volume of the ammonia is 0.0635 cubic meter/kg, which means that its density is 15.74 kg/cubic meter.

From the above, it can be deducted that, with each stroke of 1 cubic meter, the amount of ammonia vapor displaced by first piston 221 is 4.86 kg. In the same time, the amount of ammonia vapor displaced by piston 222 is 46.59 Kg (15.74 kg/cubic meter×2.96 cubic meters). Thus, the ratio of ammonia to be recycled back into chamber 211 and chamber 212 is 4.86/46.59 or 1:9.5, respectively.

The work required to return the liquid ammonia to the respective chambers is a function of its density or volume and the pressure difference of the respective chambers (the specific volume of liquid ammonia is 0.0015 cubic meter/kg):

Work=V(P1−P2)

Work Gain (4.86 kg moved from chamber 213 to chamber 211):
Work 1=4.86 kg (0.0015 cubic meter/kg) (6.15−15.54) bars, or
Work 1=4.86 kg. (0.0015 cubic meter/kg) (−9.39) bars, or
Work 1=−0.0684 cubic meter×bar

Since one part of liquid ammonia (i.e., 4.96 kg) is returned to chamber 211, the difference of 41.73 kg (i.e., 46.59 kg−4.86 kg) is returned to chamber 212.

Work Expended (41.73 kg moved from chamber 213 to chamber 212)
Work 2=41.73 kg. (0.0015 cubic meter/kg) (20.33−15.54) bars, or
Work 2=41.73 kg. (0015 cubic meter/kg) (4.79) bars, or
Work 2=0.2998 cubic meter×bar
Net Work Expended=(0.2998−0.0684)=0.231 cubic meter×bar

### Conventional Air Conditioning

The conventional method of air conditioning does not utilize second chamber 212 but does require the equivalence of pumping ammonia in the form of vapor from first chamber 211 to third chamber 213. The conventional method does not use a mechanical leverage advantage system. The work required in pumping 1 cubic meter or 4.86 kg of ammonia vapor from chamber 211 to chamber 213 may be determined as follows:

Work=V(P2−P1)

Volume of 4.86 Kg of ammonia vapor in chamber 211=1 cubic meter

Pressure of ammonia vapor in chamber 211=6.15 bars

Pressure of ammonia vapor in chamber 213=15.54 bars

W=1 cubic meter×(15.54−6.15) bars=1 cubic meter×9.39 bars=9.39 cubic meter×bar

### Comparison Using Mechanical Advantage Versus Conventional Method

The work required for pumping a given quantity of ammonia (NH3) from one pressure to another is directly related to its specific volume as described earlier. Therefore, comparatively speaking, the work required for pumping a certain quantity of NH3 in the form of a gas is significantly greater than pumping the same quantity of NH3 in the form of a liquid.

The work required for pumping 1 Cubic Meter of NH3 vapor from chamber 211 to chamber 213 using the conventional method is 9.39 Cubic Meter×bar as determined above. The conventional method requires pumping NH3 in the form of a vapor. The NH3 vapor, having a much higher specific volume than that of NH3 liquid, requires significantly much more energy.

In the mechanical advantage system, the work of pumping the vapor from chamber 211 to chamber 212, and ultimately condensing it in chamber 213, is achieved by the boiling of liquid NH3 in chambers 211 and 212 and the condensing of NH3 vapor in chamber 213. Although work is necessary to return NH3 in the form of a liquid back into chamber 211 and 212, the advantage is that liquid NH3, having a much lower specific volume, requires less work than pumping NH3 vapor. As determined earlier, the conventional method of pumping ammonia vapor requires 9.39 Cubic Meter×Bar of work per one kilogram of ammonia, while the mechanical leverage advantage method requires only 0.231 Cubic Meter×Bar for the return of the liquid ammonia to its original state. It follows that, the mechanical advantage system requires 40.64 times (9.39/0.231=40.64) less energy than the conventional method. That's a very significant energy saving advantage.

### Decreasing the Temperature Difference Between Second Chamber and Third Chamber by Increasing the Area of Second Piston Relative to First Piston

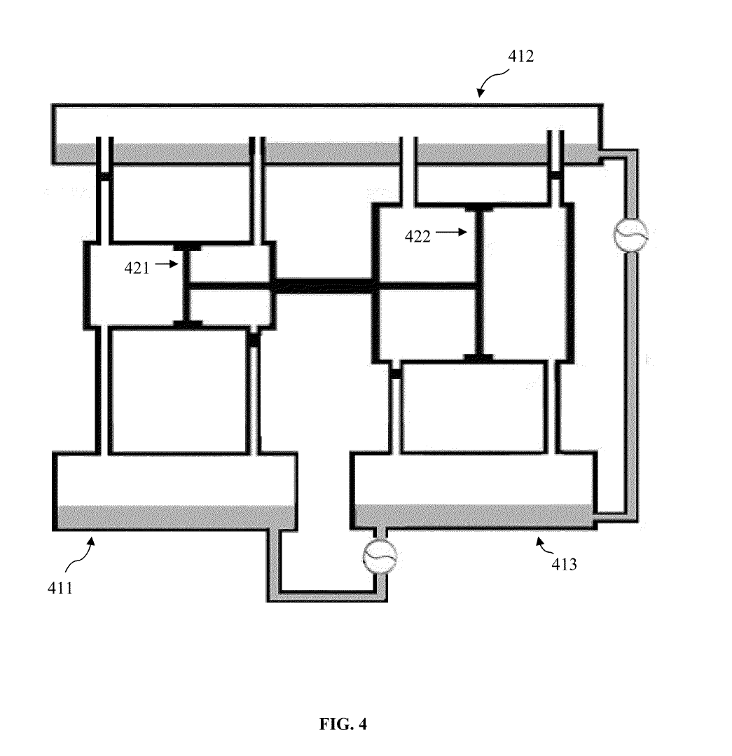

FIG. 4 illustrates a diagrammatic view of an air conditioning system, using mechanical leverage and refrigerant, according to another embodiment. The elements of the system in FIG. 4 are the same as those of the system depicted in FIG. 2, except that the temperature and the pressure in second chamber 412 are smaller, while the area of second piston 422 is greater.

By increasing the area of second piston 422 relative to first piston 421, the pressure difference between second chamber 412 and third chamber 413 may be decreased. Consequently, there is a decreased temperature difference between the points at which the NH3 refrigerant boils in chamber 412 and condenses in chamber 413. This is a valuable concept, in that it also lowers the temperature at which the NH3 refrigerant will boil in chamber 412. This is especially valuable on days with diminished sunlight and when the temperature of the attic is not sufficient to power the system.

For exemplification purposes, let's assume that the area of second piston 422 is increased to be 6 times greater than the area of first piston 421. This means that the area of second piston 422 in FIG. 4 is approximately double relative to second piston 222 in FIG. 2. Using similar pressure parameters for first chamber 411 and third chamber 413 as those listed earlier for the system in FIG. 2., the value of the pressure (P2) in the second chamber 412 may be determined from the following equations:

(P2−P1)×A1=(P2−P3)×A2
If A1=1 unit, A2=6 units; then,

(P2−6.15) bar=(P2−15.54)bar×6;
it results that,
P2=17.41 bars.

At a pressure of 17.41 bars, the boiling point of NH3 in second chamber 412 is approximately 112 degrees F. Thus, the increased (i.e., double) area of piston 422 lowered the required temperature of second chamber 412 from 122 degrees F. to 112 degrees F. This means that at this considerably lower attic temperature, the system still remains functional.

During hot and sunny days, the temperature of the attic of a house would normally reach 122 degrees F. However, second chamber 412, at this temperature level, absorbs heat from the attic at a more rapid rate and will maintain the attic cooler, closer to the range of 112 degrees F., and cooler attic spaces translate to cooler living spaces. Additionally, the excess heat in the attic may be converted into energy as discussed in the following section.

### Energy Surplus by Increasing A2/A1 Ratio

The parameters of the system can be changed to make the system run without any input of energy or even to create a surplus of energy. The change in parameters that would produce a surplus of energy is that which makes F2, the force acting on second piston 422, larger than F1, the force acting on first piston 421. This may be achieved by, for example, increasing the pressure/temperature of chamber 412 or increasing the surface area of piston 422 with respect to piston 421. This conclusion may be deducted from the following formulas:

Force 1<Force 2, or

(P2−P1)×A1<(P2−P3)×A2

For example, if starting with the same parameters for the system in FIG. 4, as described earlier, the temperature (112 F) in second chamber 412 may be allowed to reach 122 degrees F. and the pressure 20.33 bars (from 17.41 bars). This may be achieved by locking piston 422 and releasing it when the pressure builds up to 20.33 bar.

If, for example, A1 is 1 square inch and the area A2 is increased to 6 times A1, it follows that:

(20.33−6.15) Bar×1 sq. inches<(20.33−15.54) Bar (6 sq. inches), or

14.18 Bar (sq. inches)<4.79 Bar (6 sq. inches), or

14.18 Bar (sq. inches)<28.74 Bar (sq. inches);

Because with each stroke both pistons 421 and 422 travel the same distance (e.g., 1 foot or 12 inches), then:

Work 1=14.18 Bar (12 inches) and Work 2=28.74 Bar (12 inches), or

Work 1=170.16 Bar×Cubic inches, and Work 2=344.88 Bar×Cubic inches

From the above, it may be deducted that, for example, by increasing the surface area of piston 422 from 2.97 square inches to 6 square inches, a work surplus of 174.72 (344.88−170.16) Bar×Cubic inches is obtained. This work surplus may be used to generate electricity by coupling the system to a generator.

One of ordinary skills in the art would recognize that the system may be configured to have a fixed (i.e., unchangeable) ratio or a flexible (i.e., changeable) ratio between the areas of second piston 422 and first piston 421 or between the work they perform. When the system is configured with a fixed ratio, it may be preferred to use from the start an “oversized” system having a relatively larger ratio than the ratio determined as needed for the system to be functional, given the estimated ambient temperature for second chamber 412 (e.g., attic temperature). By doing so, it may be ensured that the system will still function should the ambient temperature drop below the estimated level. Furthermore, as explained earlier, during hot days, an “oversized” system may convert any work surplus in electricity.

The system may also be configured to have the flexibility to adjust the ratio as needed in order to make the system still functional during a drop in the ambient temperature or to make the system generate electricity. In one example, this may be achieved by using a variable gear link between first piston 421 and second piston 422 in order to change the distance traveled by, for example, second piston 422, and therefore, the volume of vapor displaced per stroke by pistons 421, 422, and hence, the ratio between the work performed by the two pistons. In another example, a cluster of a plurality (i.e., two or more) of first pistons and/or second (i.e., larger) pistons may be used, with the system being capable to engage and disengage pistons as necessary, to achieve the desired ratio at given temperature/pressure levels.

### Disengagement of First Chamber to Generate Electricity

If the temperature in the living area is adequate, the cooling portion of the system may be disengaged by bypassing first chamber (e.g., 211 or 411), thus making the system work solely to generate electricity.

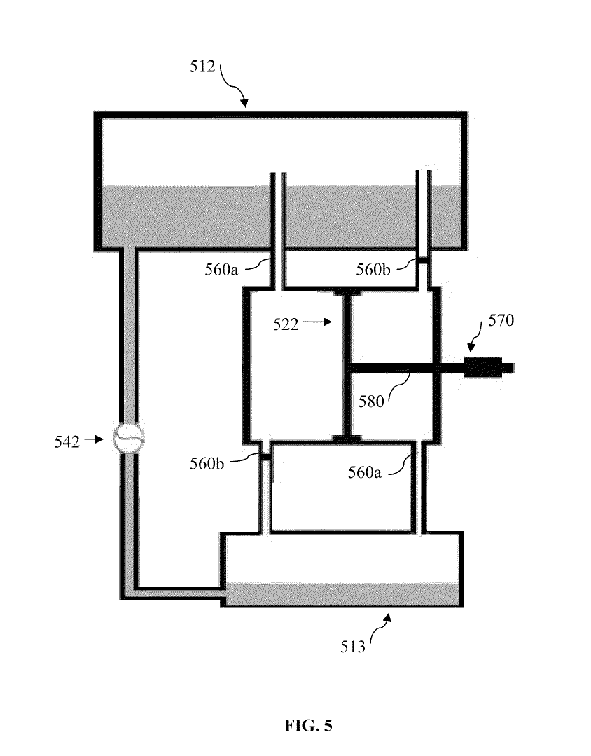

FIG. 5 illustrates a diagrammatic view of a system as in FIG. 2 without first chamber, first piston, and their respective refrigerant returns, according to another embodiment. For exemplification purposes, as in FIG. 2, ammonia is used as refrigerant, which has the same parameters in second chamber 512 as in 212 and in third chamber 513 as in 213. First chamber 211 (not shown in FIG. 5) is disengaged and the NH3 liquid return to it is turned off. The NH3 liquid return to second chamber 512 from third chamber 513, including the pump 542, remains intact. To summarize, first chamber (not shown in FIG. 5) is disengaged, second chamber 512 contains ammonia at a pressure of 20.33 bars and a temperature of 122 degrees F., and third chamber 513 contains ammonia at a pressure of 15.54 bars and a temperature of 104 degrees F.

Let's assume that the surface area of the piston 522 is 6 square inches and each stroke of the piston 522 travels 12 inches. Then, from

Work=Difference in Pressure×Volume, it results that,

Work Gained is: (20.33−15.54) bars×6 sq. inches×12 inches, or

4.79 bars (72 cubic inches), or

344.88 bar×cubic inches

From the formula, Force=(P1−P2)×A, the force exerted on piston 522 may be calculated as follows:

F=(20.33−15.54) bars×6 sq. inches, or

F=4.79 bars×6 sq. inches, or

F=14.6 psi/bar×4.79 bars×(6 sq. inches), or

F=419.6 lbs.

An electrical generator apparatus 570 may be connected to the shaft 580 of the piston 522 to captures the mechanical energy produced by the system and convert it in electrical energy. The generator apparatus 570 may be in the form of a coil encasing the shaft 580 of the piston 522 while the encased portion of the shaft 580 may be compared to a magnet for inducing magnetic flux as the shaft oscillates back and forth (i.e., left and right in FIG. 5).

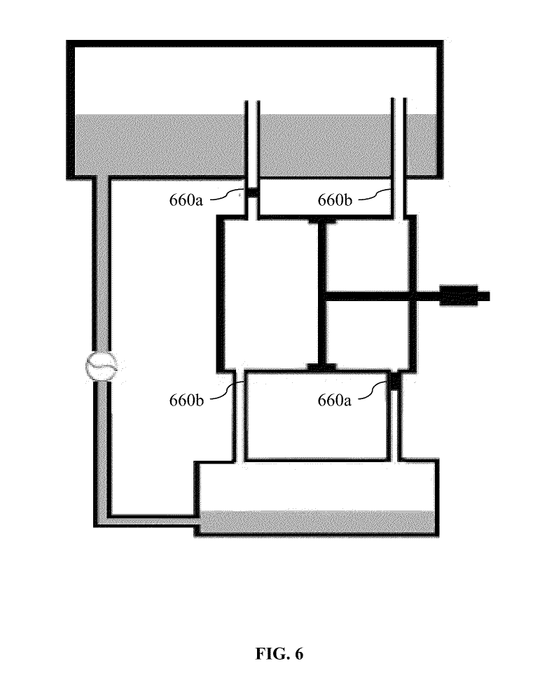

As shown in FIG. 5, the system starts with valves 560a open and valves 560b closed. When the piston 522 reaches its end point to the right, a device, such as an electronic or mechanical switch, closes valves 560a and open valves 560b. The polarity of pressure acting upon the piston 522 becomes reversed and the piston 522 will move in the opposite direction. This is depicted in FIG. 6 where valves 660a are closed and valves 660b are open.

One of ordinary skills in the art would recognize that a system may be built to completely miss first chamber and first piston, to be used, as described above, solely for the purpose of generating useful work and/or electricity. Such a system would not depart from the scope of the present invention.

### Use of Augmenting External Energy

To compensate for the lower than adequate ambient heat available to second chamber 712, in addition to increasing the surface area ratio of second piston 722 relative to first piston 721, as earlier described, external augmenting energy may be used, as described below. The two solutions may be used separately or in combination.

In FIG. 7, the depicted system is the same as in FIG. 2, except that a fourth chamber 714 and a pump 743, such as a compressor, were added. In the event that ambient and/or solar energy is not sufficient to raise the temperature of the ammonia vapor in second chamber 712 to the desired level of 122 degrees F. (see description of FIG. 1 and FIG. 2 systems above), external energy may be applied to compress and boost the pressure of the ammonia vapor and consequently increase its temperature to 122 degrees F. or any other level predetermined as optimum for allowing the system to function properly.

Let's assume that, while all other parameters are the same as in FIG. 2, the temperature of second chamber 712 only reaches 111 degrees F. At this level the temperature differential would not be sufficient to allow the system to work properly. To overcome the deficiency, a compressor 743 may be used to increase the pressure of the vapor from second chamber 712 to a higher level in the fourth chamber 714, in order for the system to remain in equilibrium and to maintain the temperature of third chamber 713 at 104 degrees F. and the pressure at 15.54 bars. So, the compressor 743 may take ammonia vapors from second chamber 712 and pump it into the fourth chamber 714 until the pressure, and consequently the temperature, of the ammonia gas arrive at the desired levels.

One of ordinary skills in the art would recognize that forth chamber 714 may be eliminated from the system's configuration without departing from the scope of the invention. The compressor 743 may be configured to alternately pump ammonia vapor from second chamber 712 directly into left side 715a (i.e., third sub-chamber) and right side 715b (i.e., fourth sub-chamber) of second cylinder 715 until the desired pressure level is achieved directly in those spaces.

It should be noted that at 111 degrees F. the pressure (P2) of the ammonia vapor in second chamber 712 is 17.34 bars. The following is the calculation for the pressure (P4) of fourth chamber 714 required to maintain the system in equilibrium and third chamber 713 unchanged at 104 degrees F. and a pressure (P3) of 15.54 bars:
(P2−P1)×A1=(P4−P3)×A2; P1 is the pressure (6.15 bars) in first chamber 711 and first sub-chamber 714a; P2 is the pressure (17.34 bars) in second sub-chamber 714b and second chamber 712; P3 is the pressure (15.54 bars) in fourth sub-chamber 715b and third chamber 713; P4 is the pressure in fourth chamber 714 and third sub-chamber 715a; A1 is the surface area of first piston 721; A2 is the surface area of second piston 722; then,
If A1=1 and A2=2.96, then
(17.34−6.15)=(P4−15.54)×2.96; it results that
P4=19.32 bars

The use of a compressor requires the input of external energy. However, the energy required is much less than that required by conventional air conditioning systems. In the mechanical leverage system, with the exception of the relatively insignificant amount of energy required to pump liquid ammonia from third chamber 713 to second chamber 712, as described earlier under FIG. 2, external energy is only required to boost the pressure of the vapor from 17.34 bars (chamber 712) to 19.32 bars (chamber 714), rather than the conventional method which requires much more pumping of vapor from 6.14 bars (from first chamber 711) to 15.54 bars into third chamber 713.

To illustrate, let's assume that the stroke for each piston for both the conventional and mechanical leverage system travels 1 meter. A rough estimate of work and comparison is as follows:

Conventional System: W=(6.14−15.54) bar×CubicMeter=9.4 bar×CubicMeter

Mechanical Leverage: W=(19.32−17.34) bar×A2×1 meter;
A2 is the surface area of second piston 722 (2.96 meters, as earlier determined for this exemplary configuration of the system); then,
W=1.98(2.96) bar×CubicMeter, or
W=5.86 bar×CubicMeter
Ratio: 5.86/9.4=0.62, or
38% less energy than the conventional method.

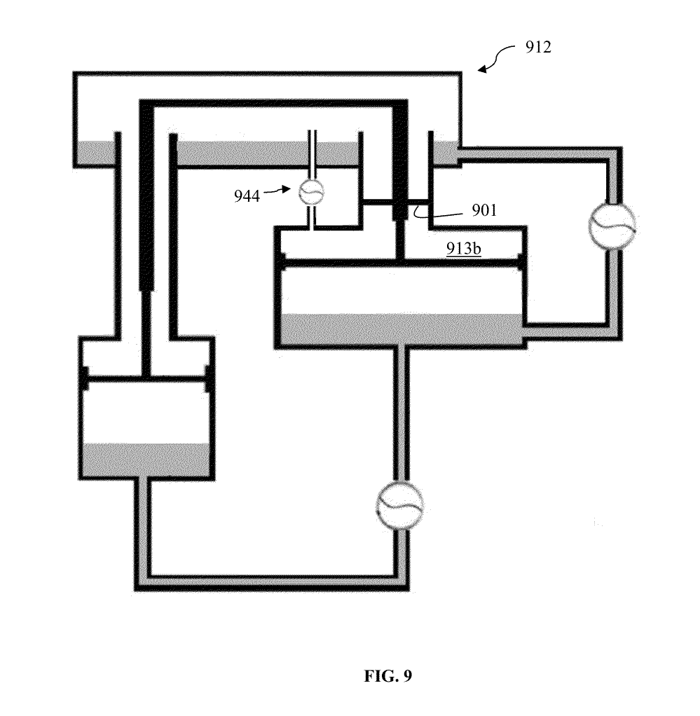

FIG. 9 depicts an augmenting external energy system using the piston and chamber configuration similar to that of FIG. 1. However, a partition 901 is placed between second chamber 912 and sub-chamber 913b separating the two chambers having distinctive temperatures and pressures. In a similar manner, as earlier described when referring to the augmentation system from FIG. 7, the pump 944 may be used to boost the pressure of the vapor from 17.34 bars, which may be the pressure in second chamber 912, to 19.32 bars in sub-chamber 913b, which is needed, under these exemplary circumstances, in order for the system to function properly. Using the same temperature/pressure parameters of the previous example, the calculations derived using this mechanical advantage configuration, also reveals a 38% less energy consumption of that of the conventional system.

If, for example, the temperature of chamber 712 reaches 114.8 degrees F., at this temperature the pressure of NH3 vapor is 18.30 bars. Using the same calculations as above, it can be determined that the mechanical advantage system is using 52% less energy than the conventional system.

As previously described the polarity of pressure is reversed by the action of the valves. By alternating the opening and closing of valves 760a and 760b, the pistons will oscillate back and forth (i.e., left and right). Again, as earlier described under FIG. 2., when the four valves 760b are closed and the four valves 760a are open, the two pistons 721, 722 move to the right. It should be noted that during this time the pressure levels of the ammonia vapor are identical in first chamber 711 and left side 714a (i.e., first sub-chamber) of cylinder 714 (6.15 bars), in the right side 714b (i.e., second sub-chamber) of cylinder 714 and second chamber 712 (17.34 bars), in fourth chamber 714 and left side 715a (i.e., third sub-chamber) of cylinder 715 (19.32 bars), and, in the right side 715b (i.e., fourth sub-chamber) of cylinder 715 and third chamber 713 (15.54 bars).

As earlier described, when the two pistons 721, 722 reach the right end of their respective cylinders 714, 715, through, for example, an electronic or mechanical switch, the process is reversed by opening valves 760b and closing valves 760a, thus, causing the two pistons 721, 722 to move to the left. When the two pistons 721, 722 reach the left end of their respective cylinders 714, 715, valves 760b are closed and valves 760a are opened again, and the process repeats itself.

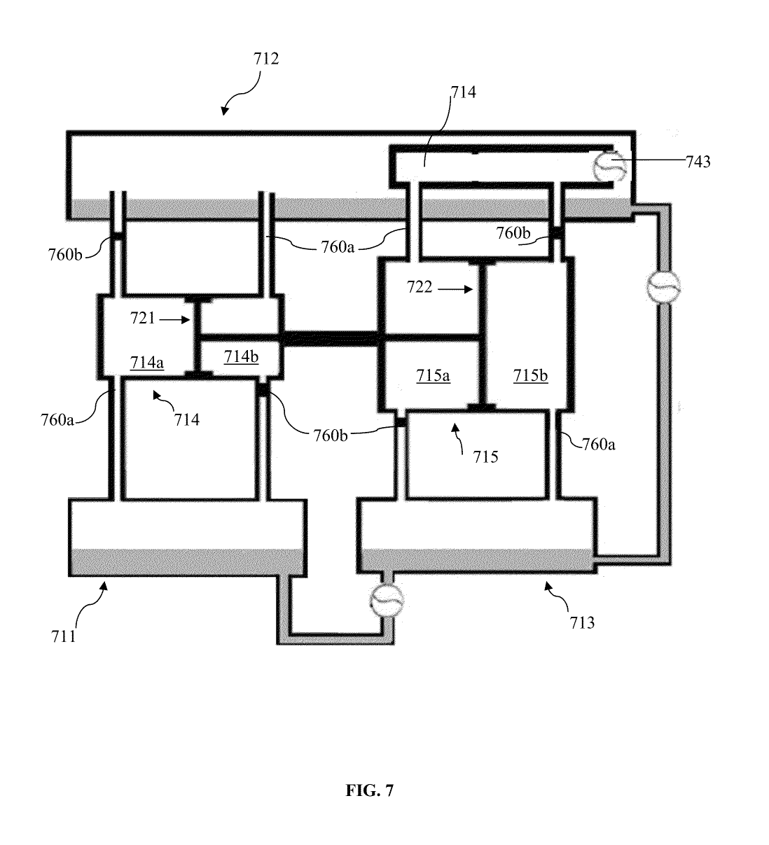

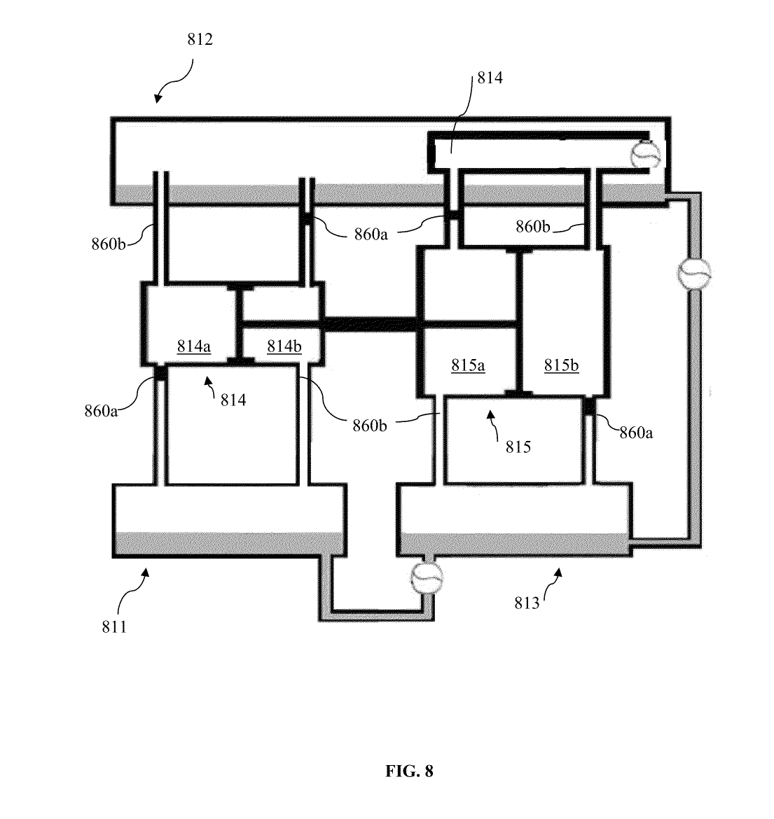

The system from FIG. 7 configured to move to the left is depicted in FIG. 8. As it can be seen, valves 860a are closed and valves 860b are open. During this time the pressure levels will balance out as follows: same pressure in first chamber 811 and right side 814b (i.e., second sub-chamber) of first cylinder 814; same pressure in the left side 814a (i.e., first sub-chamber) of first cylinder 814 and in second chamber 812; same pressure in fourth chamber 814 and right side 815b (i.e., fourth sub-chamber) of second cylinder 815; and, same pressure in the left side 815a (i.e., third sub-chamber) of second cylinder 815 and third chamber 813.

The mechanical advantage system is not limited to the use of ammonia (NH3) as the refrigerant. Other refrigerants may prove to be more effective and less expensive. Water may also be used as a refrigerant. The use of water as a refrigerant may be desirable because it has a high latent heat of vaporization and is environmentally safe. It is also inexpensive.

The pressure and the temperature levels of the refrigerant, as well as the values of other measurable characteristics of the system, such as the surface area of the pistons, are given for exemplification purposes only. One of ordinary skills in the art would recognize that alteration of these levels and values may be made without departing from the scope of the invention.

The mechanical leverage system may be reversed in the winter for use as heat pump for space heating applications. It may also be adapted for pool heating, hot water applications and/or refrigeration applications.

Some of the disadvantages of the use of a reciprocal piston mechanism as described above may be that it utilizes numerous valves with switching mechanisms for opening and closing valves at specific and synchronized times for each set of valves. Thus, in another embodiment, it may be advantageous to replace the reciprocal piston mechanism with rotary turbines, rotary pumps or scroll pumps. Rotary turbines do not require valves, hence, are simpler in design and are more reliable than reciprocal pumps. A two-cycle piston and cylinder may also be used since it also works without the use of valves. It should be noted that many other types of mechanical leverage systems may be used for this application and it is not the intent of this invention to be limited to the methods discussed here or elsewhere.

The same principles described above when referring to the reciprocal piston mechanisms (see description above referring to FIGS. 1-9) are applicable when using instead rotary turbines. As in the mechanical leverage system using the reciprocal piston system, one rotary turbine displaces larger volumes of refrigerant than a second rotary turbine. The forces acting on the two turbines are interconnected with one another, creating a mechanical advantage system. Hence, at equilibrium, the pressure difference acting upon the smaller rotary turbine is greater than the pressure difference acting upon the larger rotary turbine. The two rotary turbines are interconnected by an axle or other means in a manner in which the forces acting on the first rotary turbine is transferred to the second rotary turbine and vice versa. In this situation, the smaller rotary turbine acts as a compressor and the larger rotary pump operates in reverse and acts as an expander or pneumatic motor. The pneumatic motor generates energy sufficient to operate the compressor rotor.

Besides rotary turbines, rotary pumps, scroll pumps and the like may also be used for this application. For the purpose of this disclosure, the term turbine will be adopted, rather than pump, since pump pertains to compression and turbine may pertain to both compression and expansion.

It is well known that, at equilibrium:

Work 1=Work 2 (Eq. 1)

or,

(Difference in pressure 1)×Volume 1=(Difference in pressure 2)×Volume 2

Thus, in a mechanical advantage system, if the difference in vapor pressure acting on the first turbine is greater than the difference of pressure acting on the second turbine, then, at equilibrium, the volume of the first turbine is smaller than the volume of the second turbine. Since the vapor pressure of refrigerants are proportional to their temperature, the temperature differential associated with the first turbine having the lesser volume is greater than the temperature differential associated with the second turbine having the larger volume.

In this manner the size differential of the turbines or the mechanical advantage ratio of the turbines may be adjusted to fit the specific temperature parameters that are available in the environment and favorable to run, for example, an air conditioning system. In this example, the refrigerant used may be, for example, R-410A.

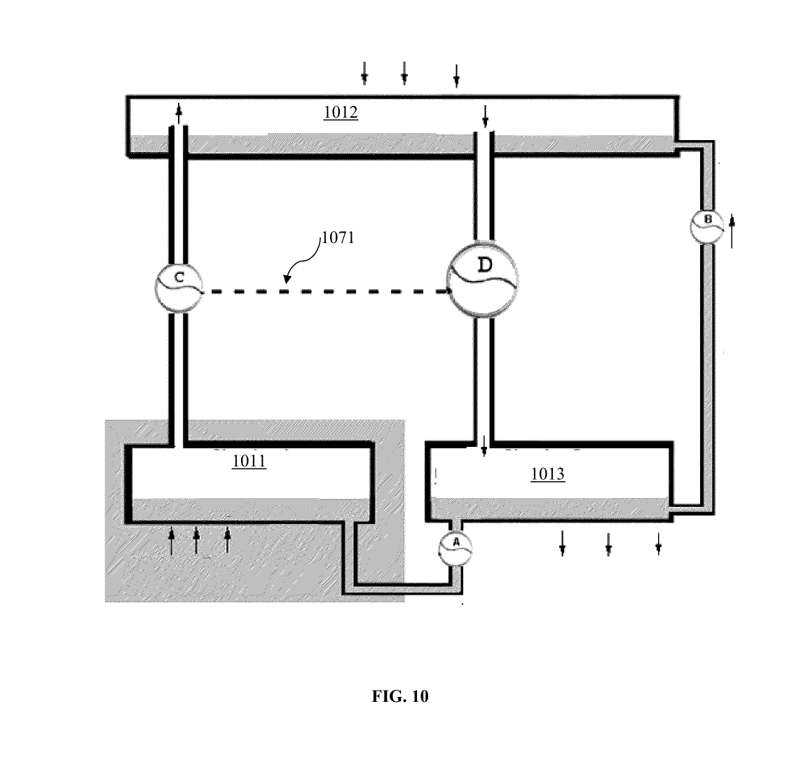

The schematic view and an exemplary set of parameters of a mechanical advantage system using turbines and R-410A as refrigerant are depicted and illustrated in FIG. 10 and described below.

Chart 1

Refrigerant in the system is R-410 A

| | | |
|---|---|---|
| Chamber 1 | Temperature 60 F. (T1) | Pressure 170.7 psi (P1) |
| (1011/FIG. 10): | | |
| Chamber 2 | Temperature 110 F. (T2) | Pressure 364.1 psi (P2) |
| (1012/FIG. 10): | | |
| Chamber 3 | Temperature 105 F. (T3) | Pressure 339.9 psi (P3) |
| (1013/FIG. 10): | | |

At equilibrium, Force 1=Force 2 (Eq. 2); F=P×A, thus, at equilibrium, the difference of pressure acting upon the internal surface area or vanes of the two turbines may be expressed as follows:

(P2−P1)×A1=(P2−P3)×A2

If A1=1 Unit (e.g., 1 square foot), then:

(364.1−170.7) psi×1=(364.1−339.9) psi×A2; or

193.4=24.2×A2; thus, A2=7.99

Hence, in this scenario, the surface area of the vanes (A2) of turbine D (see FIG. 10) may be approximately 8 times larger than the surface area of the vanes (A1) of turbine C (FIG. 10).

It is well known that Work may be expressed as P1×V1=P2×V2, and that the ratio of the surface area of the vanes of the turbines, A2/A1, is proportional to the ratio of volume displacements of the turbines (A2/A1 is proportional to V2/V1). Hence, the greater the ratio of the surface areas of the vanes in the turbines (A2/A1), the greater the ratio of volume of displacement between turbine D and turbine C. Thus, the greater the mechanical advantage produced by the turbines, and thus, the system.

Referring now to FIG. 10, chamber 1 (i.e., first chamber) 1011 acts as an evaporator and will absorb heat from the air of the room where it is installed, as the temperature of the refrigerant in chamber 1011 is lower (60 degrees Fahrenheit (F.)) than the temperature of the air in the room (72 F). Again, all the figures regarding the levels of the temperature, pressure and other parameters are given herein for exemplification purposes only. At 170.7 psi of vapor pressure, the temperature of the refrigerant used here as an example (i.e., R410-A) is 60 degrees F. The refrigerant, at this temperature, will adequately remove heat from a 72-degree F. (or higher) room. As heat is removed from the room into chamber 1011, the refrigerant within the chamber will boil and will tend to equilibrate to the point of saturation. The resultant increase of vapor pressure in chamber 1011 will have the effect of a pushing force exerted on turbine C.

Chamber 2 (i.e., second chamber) 1012 may contain R410-A refrigerant at a pressure of 364.1 psi. The refrigerant at this pressure will require a temperature of 110 degrees F. to boil. The resultant increase in vapor pressure due to boiling of the refrigerant has a pushing force on both turbine C and turbine D. However, since turbine D displaces a greater volume of vapor than turbine C, the pushing force exerted on turbine D is greater than that of turbine C. Heat may be acquired from the ambient space of, for example, the attic of a house or other spaces where chamber 1012 is installed. Additionally, heat may be received from other sources such as solar panels or reflectors, if needed. It should be apparent that the heat source (e.g., the attic of a house) has to have a temperature higher than 110 F (e.g., 120 F as shown in FIG. 10), so that Chamber 1012 can absorb heat.

Chamber 3 (i.e., third chamber) 1013 acts as a condenser and may contain R410-A refrigerant at a pressure of 339.9 psi and a temperature of 105 degrees F. Because of the temperature difference, the R410-A vapor will condense, releasing heat into the cooler (e.g., 95 F as shown in FIG. 10) ambient air (e.g., the air from the outside of a house). The condensation of the vapor will have a pulling force exerted on turbine D.

It should be noted that the pressure/temperature difference between chamber 1012 and chamber 1013 may be narrower if the mechanical advantage ratio between turbines D and C is increased. The mechanical advantage ratio between turbines D and C may be increased by designing the system from the start so that it has a higher mechanical advantage ratio, or, by configuring the system so that the ratio is adjustable, by, for example, changing (i.e., increase or decrease) the gear ratio between the two turbines to compensate for the change (i.e., decrease or increase, respectively) in the pressure/temperature difference between chamber 1012 and chamber 1013. The narrowing of the necessary pressure/temperature difference makes it possible for the system to absorb heat and expel heat within the temperature ranges found in the environment. Thus, enabling the refrigerant in chamber 1012 to boil and subsequently condense in chamber 1013. Environmental temperatures are invariably uncontrollable and it becomes necessary to adjust the mechanical advantage ratio between turbine D and turbine C to adapt the leverage/advantage system to work within these parameters.

Thus, chamber 1011 acts in the system as an evaporator, chamber 1012 also acts as an evaporator and a heat collector and chamber 1013 acts as a condenser. The three interconnected chambers may be placed at different locations or may be within close proximity of each other, depending on the application. For example, chamber 1011 (the evaporator) may be placed inside the living area of a house. Chamber 1012 (the heat collector) may placed in the attic of a house. Chamber 1013 (the condenser) may be placed outside of a house. The forces exerted by the actions of turbine C and turbine D are interconnected. In this example the turbines are interconnected by means of an axle 1071. However the interconnection may be accomplished by other means such as belts, gears, pulleys, and the like.

It should be apparent that the fluid refrigerant, whether in gas-phase or liquid-phase, is transferred to the various chambers by tubing.

It will be understood by one of ordinate skills in the art that each of the three chambers will tend to reach equilibrium with one another, as changes in temperature occur. Either by the process of boiling or condensing, each chamber will strive to maintain vapor pressures corresponding to their respective temperatures and saturation levels. The boiling and condensing of the refrigerant creates a pushing and pulling force on the turbines and drives the system forward. The chief driving force of the system is the increase pressure derived from the refrigerant boiling in chamber 1012 and the decrease in pressure derived from the refrigerant condensing in chamber 1013. The difference in the two pressures acts upon turbine D.

The processes that have been described herein are similar to that of a Rankine cycle process, in that the force exerted on turbine D is that of a typical Rankine cycle, and that the force exerted on turbine C is that of a Rankine cycle in reverse powered by the leveraged energy generated by turbine D.

Typically there are four processes in the Rankine cycle, each changing the state of the working fluid:
1) The working fluid is pumped from low to high pressure; as the fluid is a liquid at this stage the pump requires little input energy.
2) The high pressure liquid enters a boiler where it is heated at constant pressure by an external heat source to become a saturated vapor.
3) The dry saturated vapor expands through a turbine, generating power. This decreases the temperature and pressure of the vapor, and some condensation may occur.
4) The vapor then enters a condenser where it is condensed at a constant pressure and temperature to become a saturated liquid. The pressure and temperature of the condenser is fixed by the temperature of the cooling coils as the fluid is undergoing a phase-change.

### Return of Liquid NH3

The condensed liquid refrigerator in chamber 1013 must be recycled back into chamber 1011 and chamber 1012 in proportion to their original amounts given off as vapor. Input of work is required at turbine B to pump the liquid refrigerator from chamber 1013 back into chamber 1012, against a pressure of 24.2 psi (i.e., the difference between 364.1 psi in chamber 1012 and 339.9 psi in chamber 1013). However, work is gained at turbine A as 169.2 psi of liquid refrigerant pressure (i.e., the difference between 339.9 psi in chamber 1013 and 170.7 psi in chamber 1011) is released into chamber 1011.

The analysis of the net work expended and the comparison with a conventional air conditioning system is similar as described above when referring to the piston-based mechanical advantage system. Thus, as shown there, for the return of the refrigerant, the mechanical advantage system consumes several times less work than a conventional air conditioning system, and that's a significant increase in energy consumption efficiency offered by the mechanical advantage system described herein.

It should be apparent that a counter resistance of 169.2 psi at turbine A is necessary to keep the system in equilibrium.

### Energy Augmentation

In the following discussion referring to FIGS. 11-14 turbine C will be termed a compressor and turbine D will be termed a pneumatic motor.

In the event that heat from the sun, collected for example from the attic of a house, is insufficient to raise the temperature level of the refrigerant in the second chamber (1112 in FIGS. 11) to 110 F, external energy may be applied to supplement the system. The energy applied may be in the form of a motor E connected to the pulley of the external drive of either the compressor C or the pneumatic motor D (as shown in FIG. 11). In each instance, either when connecting to the compressor C or when connecting to the pneumatic motor D, the energy supplied by motor E is an augmentation to the system.

Assuming that the outside temperature is 95 F (i.e., around chamber 1113) and the temperature of chamber 1112 only reaches 103 F. At this level, the temperature differential would not be sufficient to allow the system to work properly. To overcome the deficiency, external energy provided by motor E is applied to the system in order for the system to remain in function.

The following is the calculation for the work deficiency when the pressure of the refrigerant in chamber 1112 (FIG. 11) only reaches 103 F, and the required work to maintain the system in equilibrium.

At 103 F the vapor pressure of R410A is 355 psi.

It is known that: Work 1=Work 2, or P1V1=P2V2, or, (P2−P1)×V1=(P2−P3)×V2.

We will assume that turbine D displaces 8 times more volume than turbine C per each revolution of each turbine as described earlier. Then, if V1=1 cubic inch (in), V2=8 cubic in. Thus, (355−170.7) psi (V1)=(355−339.9) psi (V2), or 184.3≢15.1(8), or 184.3>120.8.

Subtracting the expansion side from the compression side of the equation the result is 63.5 psi cubic in., or 34.4% deficiency of work ((184.3−120.8) psi. cubic in.=63.5 psi. cubic in.; 63.5/184=0.344=34.4%).

Thus, the net work needed to supplement the system is 63.5 psi cubic in. or 34.4%. This is a superior advantage offered by the mechanical leverage system. In the mechanical leverage system, external energy is only required to boost the system by 63.5 psi cubic in. as opposed to the conventional air conditioning method that would require 184.3 psi cubic in. of work, pumping vapor from 170.7 psi cubic in. to 355 psi cubic in.

When the augmenting work/energy is applied, for example, by an electric motor E, to either the compressor C or pneumatic motor D, the pressure in chamber 1113 is increased favoring condensing of the refrigerant and causing heat to be expelled to the outside ambient air. The pressure in chamber 1111 is decreased favoring evaporation of the refrigerant causing heat to be absorbed from the inside of the living space. The pressure of chamber 1112 is increased by chamber 1111 and simultaneously decreased by chamber 1113. However, chamber 1111 increases the pressure of chamber 1112 by a 1 part portion by volume, while chamber 1113 decreases the pressure of chamber 1112 by a portion of 8 parts by volume. This ratio is determined by the mechanical advantage factor between the displacement of the volume of vapor between the compressor C and the pneumatic motor D as described earlier. Thus, the overall pressure of chamber 1112 is decreased. Consequently, the temperature at which the refrigerant in chamber 1112 boils is also decreased, favoring increased absorption of heat from the attic. Thus, the system remains functional and efficient even at a lower temperature level in chamber 1112 (103 F in this example).

Energy from the Attic Harnessed and Mechanically Leveraged

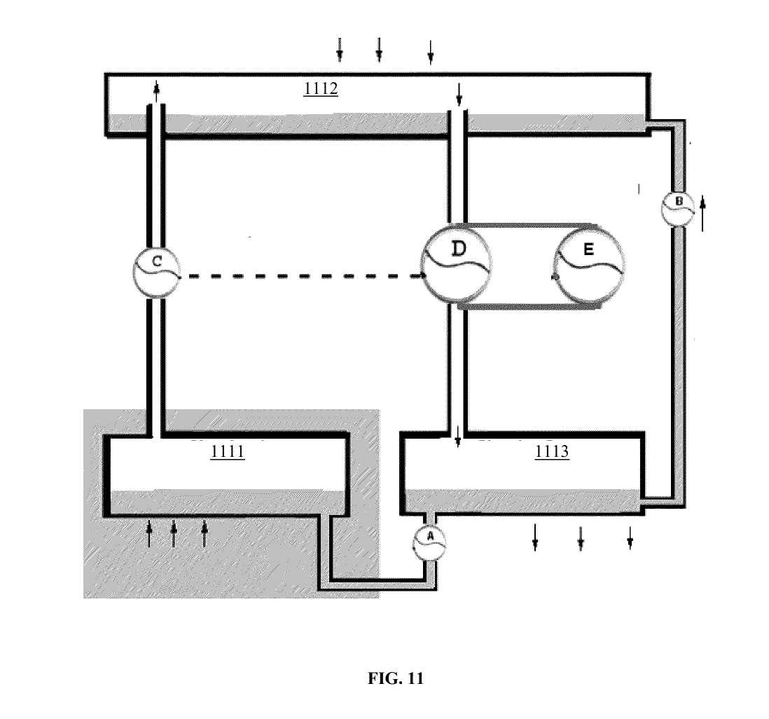

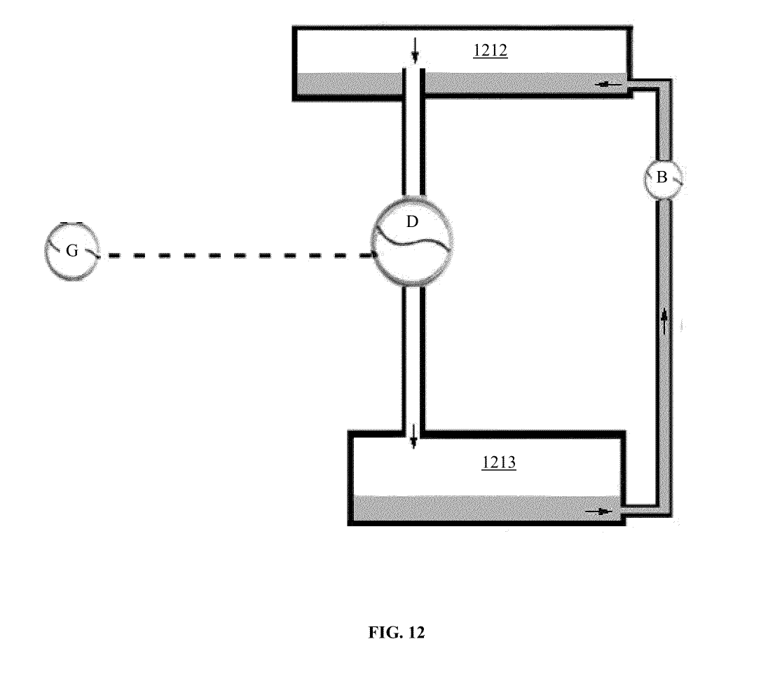

In another embodiment, when there is a surplus of energy from the system, the first chamber (not shown in FIG. 12), the compressor (not shown in FIG. 12), and return line (not shown in FIG. 12) for liquid refrigerant from chamber 1213 to the chamber 1211 are disengaged. The refrigerant, in the liquid form, returning to chamber 1212 from chamber 1213 remains on as shown in FIG. 12. Other than the exceptions listed above, the mechanical leverage system, as well as the parameters regarding chambers 1012, chamber 1013 and turbine D in FIG. 10 are identical to those regarding chamber 1212, chamber 1213 and turbine D in FIG. 12.

The energy potential between the pressure difference of chamber 1212 and chamber 1213 is harnessed to the pneumatic motor D and is leveraged to actuate an electrical generator G. Thus, the system may convert the excess heat from the attic of a house into electrical energy. The energy produced may be stored in batteries.

### System Leveraged for Air Compression

In another embodiment, as shown in FIG. 13, the power from the pneumatic motor D may be leveraged to run a compressor C1 and the compressed air may be then stored in a tank/reservoir 1314 or in more than one tank. In certain circumstances, it may be more advantageous to use the system as a household compressor, as it will described below, rather than generate electricity as described above when referring to FIG. 12. Compressed air, stored in suitably sized tanks, may be a more efficient method of storing energy as opposed to generating electricity and storing the energy in batteries. This is especially true when the mechanical energy derived from the pneumatic motor is used to run another mechanical device. There is always a substantial loss of energy, when energy is converted from one form to another as in this case where mechanical energy is converted to electrical energy.

A dispensary of compressed air may be placed within the house or garage, or the like, and may be used to refill portable canisters. The canisters filled with compressed air may be fitted to run air tools. Pneumatic equipment have less movable parts, and thus, are more reliable. They are also more convenient to use and less expensive to manufacture. These devices may include chain saws, lawn mowers, vacuum cleaners, garbage disposals, scooters, mopeds, and so on.

FIG. 13 is an illustration of the system using mechanical leveraging to generate compressed air. As shown, the pneumatic motor D is re-routed to an air compressor C1. The compressor (not shown in FIG. 13) to the air conditioning system is temporarily disengaged and coupled to an air compressor. This may be achieved with the use of linkages that shift sprockets, pulleys, belts or the like from the drive of the air conditioning compressor to the drive of the air compressor, and vice versa, so that the pneumatic motor D drives the air compressor C1, or the air conditioning compressor (not shown in FIG. 13; see C in FIG. 10), respectively. The air compressor C1 draws air at a pressure of 1 (one) atmosphere (Atm) from the surrounding space which will typically be in communication with the outside of a house, garage, or the like. In the same time the compressor C1 compresses the air to 208.1 psi, as it will be shown and derived from the following calculations. Again, it is known that,

Work 1=Work 2, or

(P4−P0)V1=(P2−P3)V2

As in the previous applications described above, V1 equals one unit and V2 equals 8 units for the mechanical advantage system described herein for illustration purposes. Thus, the mechanical advantage is 1:8. Using similar parameters as in the previous air conditioning application described above, we have:

(P4−1 Atm.) V1=(P2−P3) V2, where P4 is the pressure in tank 1314; this means that:
(P4−14.7) psi cubic in.=(364.1−339.9) psi cubic in. (V2), or
(P4−14.7) psi cubic in.=24.2 psi (8 cubic in.); thus,
P4=193.4 psi+14.7 psi; or
P4=208.1 psi, where P0 is the outside atmospheric pressure, P2 is the pressure in chamber 1312, P3 is the pressure in chamber 1313 and P4 is the pressure in tank 1314.

It should be noted that the energy derived from the pneumatic motor D may also be directly leveraged to run the compressor of a conventional air conditioner. Alternatively, a conventional air conditioner may be run by the compressed air or electricity generated from the system obtained as described above.

Similarly as described earlier, the condensed liquid refrigerant in chamber 1313 must be recycled back to chamber 1312 in proportion to its original amount given off as vapor. Again, input of work is required at turbine B to pump liquid refrigerant from chamber 1313 into chamber 1312, against a pressure of 24.2 psi.

### System Running a Heat Pump

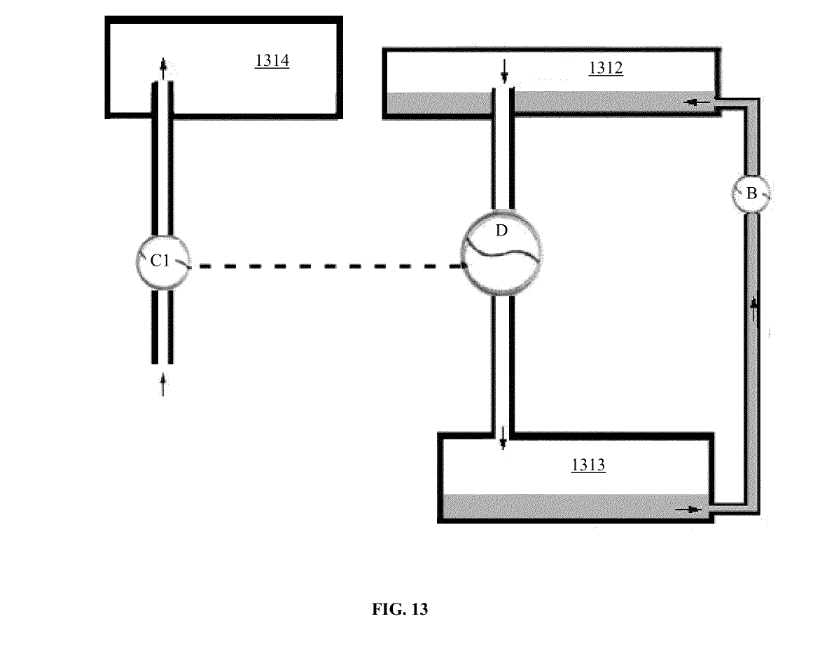

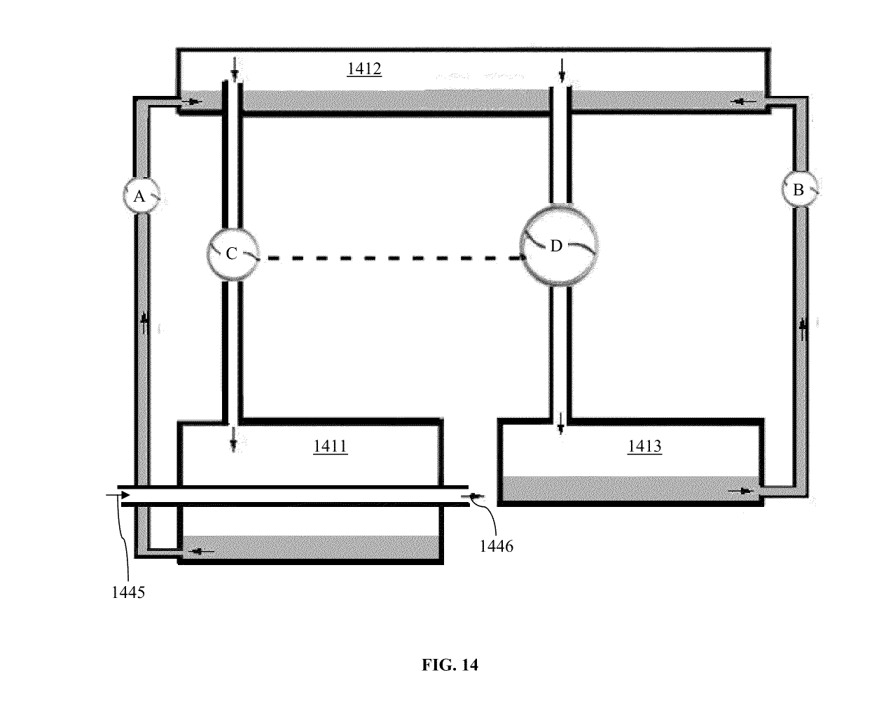

In still another embodiment, the work generated from the pneumatic motor D may be leveraged to run a heat pump as shown in FIG. 14 and as it will described below. This application may be useful to heat, for example, water for hot water heaters, swimming pools, Jacuzzis, and so on. Other liquids may be heated as well for various purposes.

In this embodiment, chambers 1411 and 1413 act as condensers and chamber 1412 as evaporator. The vapor generated in chamber 1412 is preferably leveraged to a higher pressure, and thus, a higher temperature in chamber 1411. Heat is conducted and transferred, from the condensing vapor in chamber 1411 to the water to be heated.

Referring now to FIG. 14, refrigerant R-410A is vaporized in chamber 1412 by the heat obtained from the attic. The vapor pressure of R-410 in chamber 1412 at 110 F temperature is 364.1 psi. Tank 1413 acts as a condenser. The vapor pressure of R-410 in chamber 1413 at 105 F temperature is 339.9 psi. Assuming the outer temperature is less than 95 F, the R410-A vapor within chamber 1413 will condense, releasing heat into the cooler ambient air (e.g., the air from the outside of a house). The pressure differential created between chamber 1412 and chamber 1413 actuates pneumatic motor D. The energy generated by the pneumatic motor D is leveraged and actuates compressor C. The vapor from chamber 1412 is then compressed to a higher pressure and temperature in chamber 1411 by compressor C.

Using a 4.5:1 mechanical advantage, the leveraged pressure is 474 psi and the temperature is 130 F as it will be shown and derived below. The incoming cool water 1445 is then piped through the 130 F vapor chamber 1411. As the high pressure heated vapor comes into contact with the piping containing the cool water, heat is transferred by the condensing vapor and is conducted through the piping and heats the water. Thus, hot water 1446 is obtained. The longer the incoming water travels through the conducting tube and absorbing heat from the condensing vapor, such as by passing the water through a spiral, or coils, its temperature becomes closer to that of the vapor in chamber 1411 (i.e., 130 F).

Thus, chamber 1411 acts as a condenser.

The 4.5:1 mechanical advantage ratio is derived as follows:

Work 1=Work 2, or, P1V1=P2V2; or, (P1−P2)×V1=(P2−P3)×V2, wherein P1 is the pressure in tank 1411, P2 is the pressure in tank 1412, P3 is the pressure in tank 1413.

If V1 equals 1 unit, then: (474−364.1) psi cubic in.=(364.1−339.9) V2, or, 109.9 psi cubic in.=24.2 psi V2. Thus, V2=4.5 cubic in.

As described earlier, also in this embodiment, the condensed liquid refrigerant in chamber 1413 and chamber 1411 must be recycled to chamber 1412 in proportion to its original amount given off as vapor. Input of work is required at turbine B to pump R-140A liquid from chamber 1413 into chamber 1412, against a pressure of 24.2 psi. However, here also, work is gained at turbine A as approximately 110 psi of liquid-phase refrigerant pressure (i.e., 474 psi in chamber 1411 minus 364.1 psi from chamber 1412) is released from chamber 1411 into chamber 1412. A counter resistance of 110 psi at turbine A is necessary to keep the system in equilibrium and release as needed.

If the same pneumatic motor D is being used for the water heating system, that is being used for the air conditioning system, having a mechanical advantage of 1:8, then the compressor C of the water heating system in FIG. 14 has to displace a ratio of 1.77 cubic in. per revolution as the pneumatic motor D displaces 8 cubic in. per revolution, as shown/derived below:

Mechanical advantage=V2/V1

If v2=8 cubic in.; then we have 4.5=8V1; thus, V1=1.77 cubic in.

It should be noted that the heat pump application described above would similarly work with the piston-based mechanical advantage system described earlier in this disclosure. It should also be noted that whether turbines, pistons or the like are used by the system, the heat pump aspect as described above may be used for other heating applications such as the heating of a house.

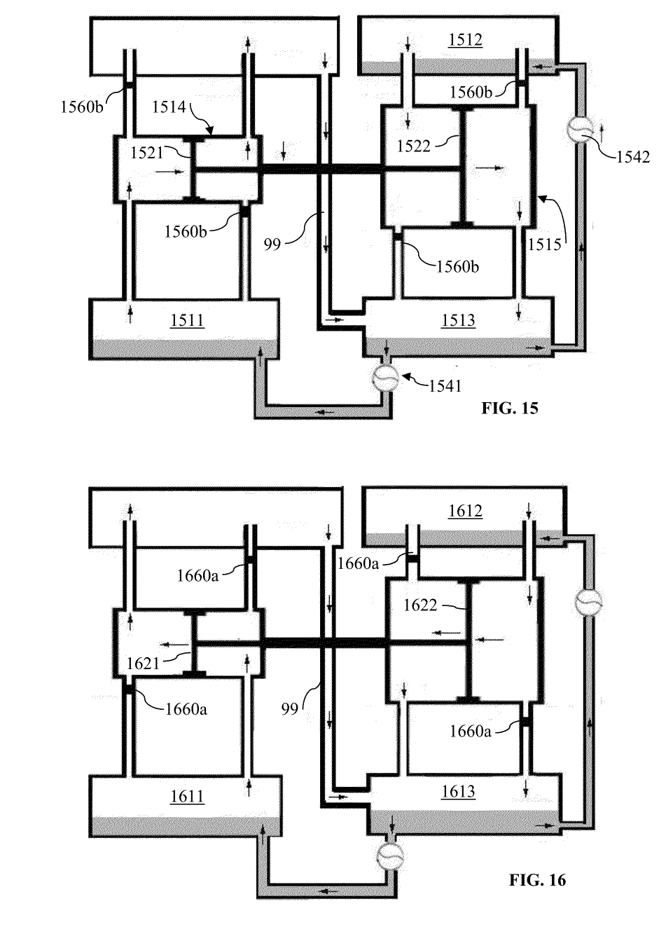

Referring now to FIGS. 15-20, improved reciprocal piston based mechanical advantage/leverage systems are depicted, in accordance with several embodiments. Reciprocal piston systems were also described earlier herein when referring for example to FIGS. 2-4. The difference in the systems depicted in FIGS. 15-20 is that the refrigerant vapor from first chamber (1511 in FIG. 15), which is one of the two evaporators of the system, is compressed and transferred directly to the third chamber (1513 in FIG. 15), the condenser of the system, rather than being transferred to the second chamber (1512 in FIG. 15), the other evaporator of the system, as previously described when referring to FIGS. 2-4. The advantage is that the refrigerant (e.g., R-410A) vapor from first chamber 1511 need only be compressed to the pressure level of third chamber 1513, which is lower than the pressure of second chamber 1512. This improvement reduces energy consumption considerably.

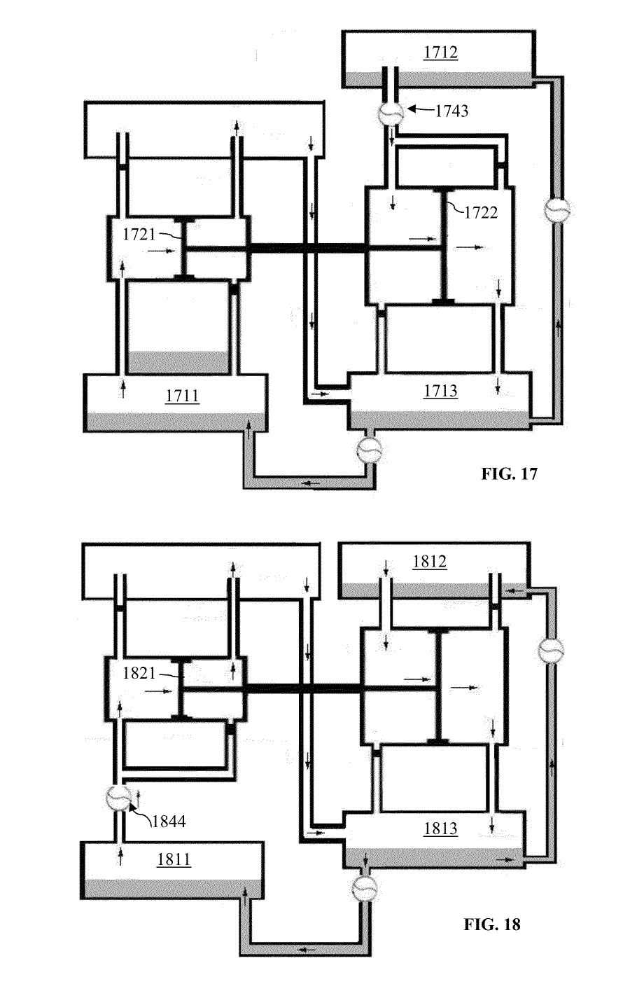

Additionally, alternative methods of implementing energy augmentation in mechanical advantage systems used in air conditioning will be described when referring particularly to FIG. 17-20.

As previously discussed, heat may be obtained from the attic space, or other sources, and converted into useful energy. A mechanical advantage/leverage system used in conjunction with a refrigerant may derive energy from the temperature differences between the attic space and the outside ambient air. This energy may then be leveraged by the mechanical advantage system to run an air conditioning system for example.

Again, in the reciprocal piston system, two pistons may be interconnected to one other and actuated by the push/ pull action of the refrigerant as it vaporizes and condenses. For the system to create mechanical leverage, the surface area of the first piston (1521; FIG. 15) in cylinder 1514 is preferably smaller than the surface area of the second piston (1522; FIG. 15) in cylinder 1515. It should be understood that the term “surface area of the piston” is referring herein to the pressure interface portion of the piston (i.e., the portion of the piston upon which the pressured fluid in the piston's cylinder exerts force).

As stated before, it is well established that: (Difference in pressure 1)×Area 1=(Difference in pressure 2)×Area 2. This equation is central to the mechanical leverage system. From this equation it may be deducted that, if the difference in vapor pressure acting on the first piston is larger than the difference of pressure acting on the second piston, then the surface area of the first piston is smaller than the surface area of the second piston. Since the vapor pressure of refrigerants is proportional to their temperature, the temperature differential associated with the first piston, having the smaller surface area, is greater than the temperature differential associated with the second piston, having the larger surface area. Furthermore, increasing the surface area of the second piston in relation to the first piston decreases the pressure/temperature difference necessary to act on the second piston, thus, making it possible for the system to work within the temperature ranges found within the environment (e.g., attic temperature and outside temperature).

As stated before, the second chamber (1512 in FIG. 15), containing refrigerant, R-410A or the like, and serving as an evaporator and power source for the system, is placed in the attic space near the apex or ridgeline of the roof. The absorption of heat from the attic by the refrigerant results in the refrigerant boiling. The resultant expansion of the refrigerant into a gas generates energy and acts upon the larger second piston 1522, having a pushing effect. Conversely, refrigerant gas is condensed in third chamber 1513, causing a lowering of pressure and has a pulling effect on both, the first and the second piston 1522. However, second piston 1522 having a greater surface area than first piston 1521, the force exerted on piston 1522 is greater than the force exerted on piston 1521. Thus, as shown in FIG. 15, second piston 1522 (and first piston 1521) moves to the right and valves 1560b are closed and all the other valves (see 1660a in FIG. 16 for their location) are open. The process is reversed and both pistons will move to the left (see FIG. 16), when valves 1560b are open and valves 1660a are closed.

Hence, the driving force acting on the second piston is the pressure difference between second chamber 1512 and third chamber 1513. The energy acting on the second, larger piston 1522 is communicated to a first, smaller piston 1521. In this example, the energy exerted on the second piston is leveraged and stepped up to a mechanical advantage of 1/3.7, as it will shown/derived below. The stepped up force in turn drives the smaller, first piston 1521, which acts as a compressor. The compressor draws refrigerant gas from first chamber 1511, resulting in a lower pressure therein and causing the refrigerant to boil and absorb heat from the surrounding area (e.g., the living area of a home). As shown in FIGS. 15 and 16, the resultant compressed refrigerant vapor is ultimately transferred from first chamber 1511 (evaporator of the air conditioner) into third chamber 1513 (condenser) via conduit 99. Then, the refrigerant is recycled back, in proportion to their original amounts, from third chamber 1513 by a release type turbine/counter resistance 1541 back into first chamber 1511, and pumped by pump/turbine 1542 into second chamber 1512.

It should be noted that the mechanical leverage system depicted in FIGS. 15-20 has two evaporators, first chamber 1511 (1611 in FIG. 16), which absorbs heat from, for example, the living area of a house, and second chamber 1512/1612, which absorbs heat from the attic. It also has one common condenser, the third chamber 1513/1613, which receives refrigerant vapor from both, first chamber 1511/1611 and second chamber 1512/1612. The condenser and each of the two evaporators incorporate a means of increasing heat exchange with the use of coils, radiators and radiator fins or the like. An evaporative water cooling system may also be implemented to enhance cooling of the condenser. Additionally, water from a swimming pool may be circulated through the heat exchange system of the condenser, having a two fold function of cooling the condenser and heating the pool.

The following chart (Chart 2) relates to the parameters used in FIG. 15 and FIG. 16 (refrigerant is R-410A; however, other parameters and refrigerants may be used):

| First Chamber | Temperature 60 F. | Pressure (P1) 170.7 psi |
|---|---|---|
| 1511/1611: | | |
| Second Chamber | Temperature 120 F. | Pressure (P2) 416.4 psi |
| 1512/1612: | | |
| Third Chamber | Temperature 110 F. | Pressure (P3) 364.1 psi |
| 1513/1613: | | |

The following are the calculations derived to determine the ratio of the surface areas between first piston 1521/1621 versus second piston 1522/1622, and thus, the mechanical advantage ratio for the system:

It is known that Force (F)=Pressure (P)×Area (A); at equilibrium, the force acting on first piston is equal with the force acting on second piston, or (P3−P1)×A1=(P2−P3)×A2, where A1 and A2 are the surface areas of first and second piston, respectively. It follows that:

(364.1−170.7) psi−1=(416.4−364.1) psi×A2

193.4 psi=52.3 psi×A2
A2=3.7 sq inches

Thus, the ratio of the surface area of the first piston versus the second piston is: 1/3.7. Hence, if A1=1 square inches then A2=3.7 square inches.

For the system to be in equilibrium, work performed by first piston (W1) should equal work performed by second piston (W2), or W1=W2. Specifically, W1 represents the amount of work necessary to compress a given amount of refrigerant vapor from first chamber 1511 to third chamber 1513, while W2 represents the amount of work gained from the expansion of refrigerant gas from second chamber 1512 to third chamber 1513.

The following example illustrates the use of the aforementioned parameters of second piston 1522 (FIG. 15) displacing 3.7 times more volume than that of first piston 1521 per each stroke. For purposes of simplification, let us assume that second piston 1522 and first piston 1521 both travel 1 (one) inch and that the surface area of first piston 1521 is 1 (one) square inch. Then, we have: V1=1 cubic in. and V2=3.7 cubic in. At equilibrium, W1 (compression)=W2 expansion), or:

(P3−P1)×V1=(P2−P3)×V2

(364.1−170.7) psi (V1)=(416.4−364.1) psi (V2)

193.4=52.3(3.7)
193.4 psi. cubic in=193.4 psi. cubic in

As previously stated, work is required to compress the refrigerant gas from first chamber 1511 (1611 in FIG. 16) to third chamber 1513 (1613 in FIG. 16), but that work is 61.3 psi cubic in. less, then if the refrigerant gas would be compressed into second chamber 1512, as in the previously described system, when referring to FIGS. 2-4. To compress the refrigerant gas from first chamber to second chamber of the system depicted in FIGS. 15-20, 254.7 psi cubic in. ((416.4−170.7) psi (V1); V1=1 cubic in.) of work would be needed, which is 61.3 psi cubic in. more than the work needed to compress same quantity of refrigerant gas into third chamber ((364.1−170.7) psi (V1)=193.4 psi. cubic in; thus, 254.7 psi cubic in.−193.4 psi. cubic in=61.3 psi cubic in).

Thus, using the common condenser (second chamber) system and method depicted in FIGS. 15-20, in which refrigerant gas is compressed from first chamber to third chamber, is more energy efficient as it requires 61.3 psi. cubic in. less work.

It should be noted that the other details regarding the operation of the system depicted in FIGS. 15-16, such as the opening and closing of valves to direct the flow of refrigerant gas and the recycling of the refrigerant through the system, are similar as described earlier when referring to FIGS. 2-4, and thus, they are incorporated hereby by reference.

Again, the refrigerant in first chamber 1511 (1611 in FIG. 16) will boil and absorb heat from chamber's surroundings (e.g., the room of a house). At 170.7 psi of vapor pressure, the temperature of the R-410A refrigerant is 60 degrees F. The R-410A refrigerant at this temperature will adequately remove heat from a 75-degree or warmer room. As heat is transferred from the room to first chamber 1511, the R-410A refrigerant within the chamber will boil and cause an increase pressure as it strives to reach a state of equilibrium with the outside room temperature.

Second chamber 1512 (1612 in FIG. 16) contains R-410A refrigerant at a pressure of 416.4 psi. The R-410A refrigerant at this pressure will require a temperature of at least 120 degrees F. to boil. Heat will preferably be acquired from the attic or the mainstream duct of a heat collection system in the attic (details about such system will be described below). Additionally, heat may be obtained from solar panels or reflectors, or the like, if needed. The vaporization of R-410A refrigerant in second chamber 1512 will have a pushing force exerted on piston 1522, as stated earlier. This is the power source for the system.

The third chamber 1513 (1613 in FIG. 6) contains R-410A refrigerant at a pressure of 364.1 psi and a temperature of 110 degrees F. The R-410A refrigerant vapor will condense releasing heat into the cooler outside (95 F or less) ambient air. The condensation of the vapor will have a pulling force exerted on both first piston 1521 and second piston 1522. However, it should be apparent that, since the second piston 1522 has a greater surface area than the first piston 1521, the pulling force exerted on the second piston is greater than the force exerted on the first piston.

As previously stated, when referring to the earlier described systems, the necessary pressure/temperature difference between second chamber 1512 and third chamber 1513, may be narrower if the mechanical leverage/advantage ratio of the system is increased. The mechanical advantage ratio between second piston 1522 and first piston 1521 may be increased by designing the system from the start so that it has a higher mechanical advantage ratio, or, by configuring the system so that the ratio is adjustable, by, for example, changing (i.e., increase or decrease) the gear ratio between the two pistons to compensate for the change (i.e., decrease or increase, respectively) in the pressure/temperature difference between chamber 1512 and chamber 1513. The narrowing of the necessary pressure/temperature difference makes it possible for the system to absorb heat and expel heat within the temperature ranges found in the environment. Thus, enabling the refrigerant in chamber 1512 to boil and subsequently condense in chamber 1513. Environmental temperatures are invariably uncontrollable and it becomes necessary to adjust the mechanical advantage ratio between piston 1522 and piston 1521 to adapt the leverage/advantage system to work within these parameters.

Again, chamber 1511 and chamber 1512 act as evaporators and chamber 1513 acts as a condenser. The three interconnected chambers may be placed at different locations or may be within close proximity of each other, depending on the application. The force exerted by the second piston 1522 (the expander), drives the first piston 1521, (the compressor). The refrigerant vapor is transferred to the various chambers by tubing. Chamber 1511 (the evaporator) may be placed, for example, inside the living area of a house. Chamber 1512 (the heat collector and evaporator) may be placed in the attic. Chamber 1513 (the condenser) may be placed, for example, outside of a house such that it may expel heat to the outside.

It should be noted again that each of the three chambers will tend to reach equilibrium with one another, as changes in temperature occur. Either by the process of boiling or condensing, each chamber will strive to maintain vapor pressures corresponding to their respective temperatures and saturation levels. The boiling and condensing of the refrigerant in each chamber changes the pressure in the chambers of the system and creates a pushing and pulling force on the expander (1522) and compressor (1521) pistons and drives the system forward.

### Return of Liquid Refrigerant

The condensed liquid refrigerant in chamber 1513 must be recycled back into chamber 1511 and chamber 1512 in proportion to their original amounts given off as vapor. Input of work is required at turbine 1542 to pump liquid refrigerant from chamber 1513 into chamber 1512, against a pressure of 52.3 psi. However, work is gained at turbine 1541 as 193.4 psi (i.e., (364.1−170.7) psi) of liquid refrigerant pressure is released from chamber 1513 into chamber 1511. A counter resistance of 193.4 psi cubic inch at turbine 1541 is necessary to keep the system in equilibrium.

It should be noted that the preceding discussion referring to FIGS. 5-6 as to the disengagement or the absence/nonexistence of first chamber and related components, also applies to FIGS. 15-16 in that the first chamber 1511, piston 1521, cylinder 1514, etc, may be disengaged or absent/nonexistent such that a system similar to the one depicted in FIGS. 5-6 may be obtained.

### Vehicle Air Conditioning

In another embodiment, referring to FIGS. 15 and 16, the mechanical leverage system herein described may be used as an air conditioner, refrigerator or freezer for a vehicle where the evaporator of second chamber (1512 in FIG. 15) absorbs heat from the engine, through, for example, the exhaust, the circulating/coolant fluid, the engine oil, or a combination thereof. The evaporator of first chamber 1511 may absorb heat from the interior of the vehicle, refrigerator or freezer. The third chamber 1513, the condenser, may expel heat to the exterior of the vehicle. Again, third chamber 1513 acts as the common condenser, condensing gas-phase refrigerant generated from the evaporators of chambers 1511 and 1512.

Additionally, as previously described when referring to FIGS. 5-6, the first chamber 1511 and piston 1521 (FIG. 15) as well as the return for liquid phase refrigerant from chamber 1513 to chamber 1511 may be either disengaged or may be nonexistent. The energy captured as a result of the refrigerant boiling in chamber 1512 and condensing in chamber 1513 may be coupled to a generator or otherwise used as an energy source.

Furthermore, the embodiments of FIGS. 15-16 and FIGS. 5-6 may be implemented as a cooling source for the engine of a vehicle, where the evaporator of second chamber 1512, 512 absorbs heat from the engine and the third chamber 1513, 513, the condenser, expels heat to the exterior of the vehicle. Also, it should be noted that if the system of FIGS. 5-6, or a similar system derived from the system depicted in FIGS. 15-16 by disengaging or eliminating first chamber 1511, piston 1521, cylinder 1514, etc, were implemented solely for the purpose of cooling the engine of the vehicle, the energy capturing component of the system, for example, the generator, compressor etc (see FIG. 5; not shown in FIGS. 15-16) may be disengaged or may be nonexistent. This is a more efficient method of cooling the engine, in that the latent heat absorbed or expelled as a refrigerant boils or condenses is much greater than in the conventional method of simply circulating fluid from the engine and expelling its heat to the exterior through radiators.

### Energy Augmentation

Again, the system may be designed with a mechanical advantage ratio that is selected based on, among other factors (e.g., the type of refrigerant used), the expected temperature differentials available in the environment where the system will be used. For example, systems with greater mechanical ratio will generally be needed in cooler climates. Moreover, as explained earlier, the system may be designed such that it is capable of adjusting its mechanical ratio (e.g., by changing the gear ratio between the two pistons) so that the same system may be used in different climates, and/or, that the system operates properly in a given climate even though, as naturally expected, the temperature differentials will vary, for example from day to day. In addition to the mechanical ratio adjustability feature, the system may be equipped with augmentation feature(s) as earlier described and as specifically exemplified and described below when referring to FIGS. 17-20. As one of ordinary skills in the art would recognize, the two features may be used alternatively or concomitantly in order to compensate for a decrease in the temperature differential available in the environment.

Referring now to FIGS. 17-20, various examples of augmentation solutions will be described. In the event that heat from the sun is insufficient to raise the temperature level of the refrigerant in the second chamber (1712 in FIG. 17) to the desired level (i.e., 120 F based on the scenario described above when referring to FIGS. 15-16), external energy may be applied to supplement the system. The energy applied may be in the form of compression power by a compressor. However, other means to supplement the system may include applying force to actuate movement of the pistons mechanically with the use of solenoids, electric motors or other means.

For exemplification purposes, let's assume that the outside temperature is 95 F and the temperature of chamber 1712 only reaches 115 F. At this level, the temperature differential would not be sufficient to allow the system to work properly. To overcome the deficiency, external energy is applied to the system. In this first example, a compressor 1743 (FIG. 17) is applied between chamber 1712 and the intake portion of the cylinder of piston 1722 to overcome the deficiency.

The following chart (Chart 3) relates to the parameters used in FIGS. 17, 18, 19 and 20 (Refrigerant is R-410A):

| First Chamber | Temperature 60 F. | Pressure 170.7 psi |
|---|---|---|
| 1711/1811/1911/2011 | | |
| Second Chamber | Temperature 115 F. | Pressure 389.6 psi |
| 1712/1812/1912/2012 | | |
| Third Chamber | Temperature 110 F. | Pressure 364.1 psi |
| 1713/1813/1913/2013 | | |

What follows is the calculation for the work deficiency when the pressure in chamber 1712 only reaches 389.6 psi, (designated as P4), at 115 F, rather than 416.4 at 120 F, and thus, the additional, external work needed to maintain the system in equilibrium.

| | |
|---|---|
| Compression | Expansion |

(P3 − P1) X V1 = (P4 − P3) X V2

| | |
|---|---|
| 110 F. 60 F. | 115 F. 110 F. (temperature |
| | levels in respective chambers) |

(364.1 − 170.7)psi (V1) = (389.6 − 364.1)psi (V2)
193.4 > 25.5(3.7)
193.4 psi > 94.3
193.4 − 94.3 = 99.1 psi

Thus, there is a 99.1/193.4=51.2% pressure deficiency, which will need to be compensated by compressor 1743.

In a second example, a compressor 1844 (see FIG. 18) is applied between chamber 1811 and the intake portion of the cylinder of piston 1821. The aforementioned parameters are used in this example as well, with the temperature of the refrigerant in chamber 1812 only reaching 115 F. The pressure (P5) of the intake compartment of piston 1821 is the pressure necessary to maintain the system in equilibrium. The calculation for P5 is as follows:

(P5−P3)V1=(P4−P3)V2

(364.1−P5) psi=(389.6−364.1)psi×3.7

364.1−P5=25.5×3.7 psi

364.1−P5=94.3
P5=269.75 psi

Thus, if the pressure in chamber 1 is 170.7 psi, then an augmentation of 99.05 psi, using compressor 1844 will be necessary to run the system ((269.75−170.7) psi=99.05 psi). Using the conventional method of air conditioning, as shown in the above derivation (when referring to FIG. 17), work of 193.4 psi. cubic inches is required to compress vapor from chamber 1811 to chamber 1813. To compress the same amount of vapor, using in the mechanical leverage system, external energy is only required to boost the work by 99.05 psi cubic in. or 51.2% of the work normally needed by conventional air conditioning (99.05/193.4=51.2%).

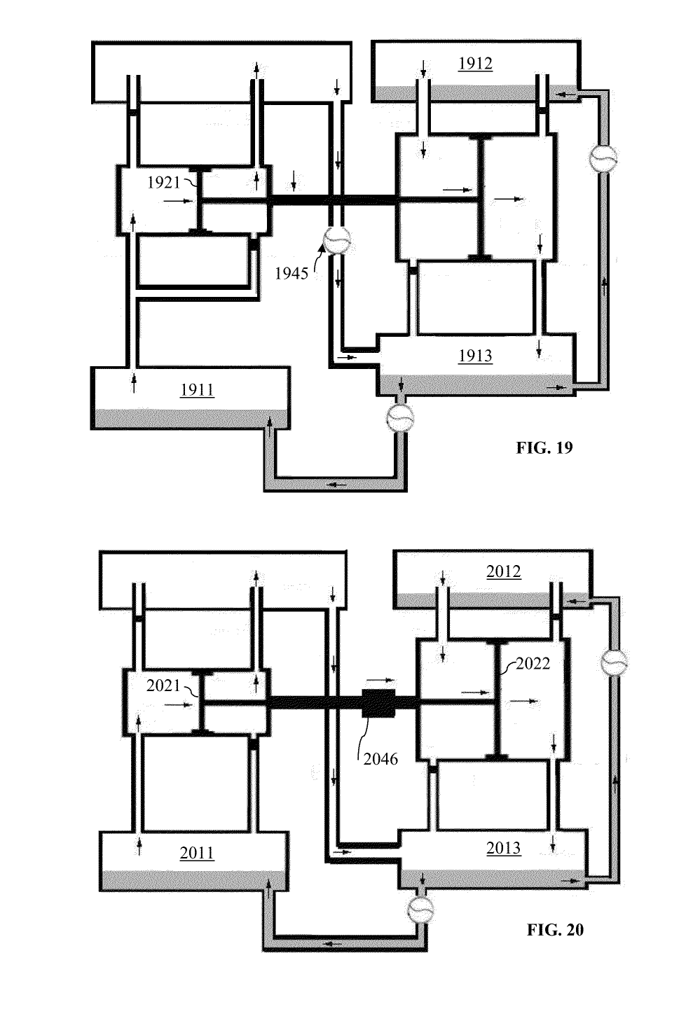

In a third example of augmentation depicted in FIG. 19, a compressor 1945 is placed between the output portion of the cylinder of piston 1921 and chamber 1913. Again, we are using the aforementioned parameters with the temperature of chamber 1912 only reaching a temperature of 115 F. The pressure (P6) of output portion of the cylinder of piston 1 is the pressure necessary to maintain the system in equilibrium. The calculation for P6 is as follows:

(P6−P3)V1=(P4−P3)V2

(P6−170.7) psi=(389.6−364.1) psi×3.7

P6−170.7 psi=25.5×3.7 psi

P6−170.7=94.3
P6=265 psi

Thus, if the pressure in chamber 1913 is 364.1 psi, then an augmentation of 99.1 psi, using compressor 1945, will be necessary to maintain the system in equilibrium ((364.1−265) psi=99.1 psi). Again, to compress the same amount of vapor, using the conventional method of air conditioning, work of 193.4 psi. cubic inches is required to compress vapor from chamber 1911 to chamber 1913. In the mechanical leverage system, external energy is only required to boost the work by a quantity of 99.1 psi cubic in. or 51.2% of the work normally needed by conventional air conditioning (99.1/193.4=51.2%).

In a fourth example of augmentation (see FIG. 20), a solenoid, motor or other mechanical device is engaged onto the shaft that communicates and transfers energy from piston 2022 to piston 2021. The augmenting work provided by such devices will need to compensate for the pressure deficiency designated as P7 in the calculations below.

The following is a calculation of the pressure and work deficiency when the temperature in chamber 2012 only reaches 115 F for this system (all other parameters being the same as above).

| | |
|---|---|
| Compression | Expansion |

(P3 − P1) X V1 = (P4 − P3) X V2
(364.1 − 170.7)psi (V1) = (389.6 − 364.1)psi (V2)
193.4 psi. cubic in = 25.5(3.7) psi. cubic in
193.4 psi. cubic in > 94.35 psi. cubic in

By subtracting the expansion side of the equation from the compression side of the equation, we have 99.05 psi. cubic in. This is the work required to compensate for the pressure (P7) deficiency, and thus, to augment the system to maintain it at equilibrium. Thus, P7=(193.4−94.35) psi=99.05 psi.

Hence, approximately 51.2% deficiency of work (99.05/193.4=0.512) has to be compensated by the device 2046. Again, using the conventional method of air conditioning, work of 193.4 psi. cubic inches is required to compress 1 cubic inch of vapor from chamber 2011 to chamber 2013. In the mechanical leverage system, external work is only required to boost the work applied to the shaft by an equivalence of work of 95.35 psi cubic in.

It should be noted that any of the preceding examples of augmentation may be utilized by itself or may be implemented in any other combination with one or more of the other examples described here. Also, these are merely examples of augmenting the system and are not intended to limit the general principle of augmentation for mechanical advantage systems.

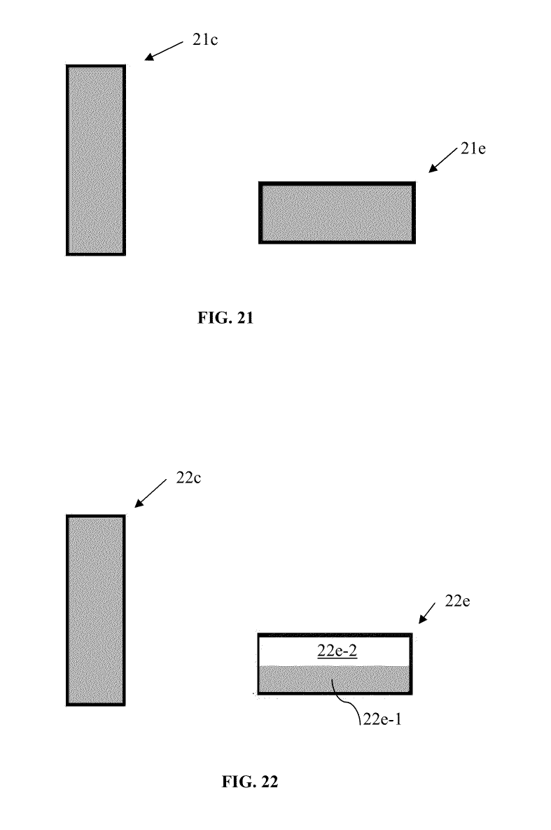

FIG. 21 depicts work in graphic form as the area of a rectangle determined by the product of pressure and volume. Pressure is depicted on the vertical axis and volume on the horizontal axis.

In a mechanical advantage system that is in equilibrium, the area of the rectangle representing the compressive side 21c of the equation is equal to the rectangle representing the expansive side 21e of the equation, or 193.4 psi. cubic in=193.4 psi. cubic in, as derived earlier when referring to FIG. 15.

FIG. 22 shows in a graphic form the work when energy augmentation is used. As calculated earlier when referring to FIGS. 17-20, based on the assumed parameters, namely the temperature in the second chamber of the system (1712 in FIG. 17) reaching only 115 degrees F., of the total work 193.4 psi. cubic in. needed on the expansion side 22e of the equation in order to equal the compression side 22c, 94.3 psi. cubic in. (22e-1) of work is provided by the expansion and 99.1 psi. cubic in.(22e-2) is provided by the augmentation.

It should be apparent that the mechanical advantage/leverage system described herein is a power source that may be employed for different applications such as air conditioning, power generation, compressed air generation, heating applications, and so on.

It should be noted that the terms “expander” and “pneumatic motor” are synonymous for the purpose of this disclosure. Also, the terms “fluid,” “working fluid” and “working medium” are synonymous for the purpose of this disclosure.

Again, the pressure and the temperature levels of the refrigerant, as well as the values of other measurable characteristics of the system, such as the surface area of the vanes of the turbines, were given herein for exemplification purposes only. One of ordinary skills in the art would recognize that alteration of these levels and values may be made without departing from the scope of the invention.

### Heat Collecting Conduit System

A great portion of the heat entering the living space of a house results from the direct rays of the sun. Due to the large surface areas of roofs, a great quantity of heat is absorbed from the direct exposure to the sun. Consequently, attic temperatures can reach substantially higher temperatures than the outside ambient air. Presently, the attic space serves as a buffer between the heat absorbed by the roof and the heat that ultimately penetrates the living area of a house.

What follows is the description of a solar heat colleting system that captures and concentrates heat from the roof. The collected heat, in conjunction with a refrigerant, is then used to fuel a mechanical leverage system.

The captured heat may be absorbed by a refrigerant, in a heat exchange coil system, located in second chamber (e.g., 1512 in FIG. 15) of the system. The absorption of heat causes the refrigerant to boil. The resultant vaporization and expansion of the refrigerant may be coupled to a piston 1522 and its cylinder 1515 (FIG. 15). The exhaust vapor leaving cylinder 1515 is channeled into third chamber 1513 acting as a condenser. Next, the exhaust vapor is condensed by the cooler outside ambient air, causing a decrease in the volume of gas. The expansion of gas in second chamber 1512 coupled with the condensing of the gas in third chamber 1513 produces a pressure difference, which powers piston 1522 in cylinder 1515. The energy derived from the piston 1522 in cylinder 1515 in turn is leveraged and stepped up to run systems such as: air conditioners, compressors, heating pump, electricity generator, and so on.

In general, the greater the temperature differential between the heat capturing system and the outside ambient air, the greater the power generated by the mechanical leverage system. In this respect, it is advantageous to maximize the quantity of heat captured from the sun and concentrate its intensity. This may be achieved, for example, by confining and limiting the volume of air, to the space between the rafters of a roof, such that the quantity of air to be heated becomes less, thus, greater temperatures can be reached. This smaller volume of air, when heated, reaches greater temperatures that are normally reached in attic spaces where the entire attic space is heated.

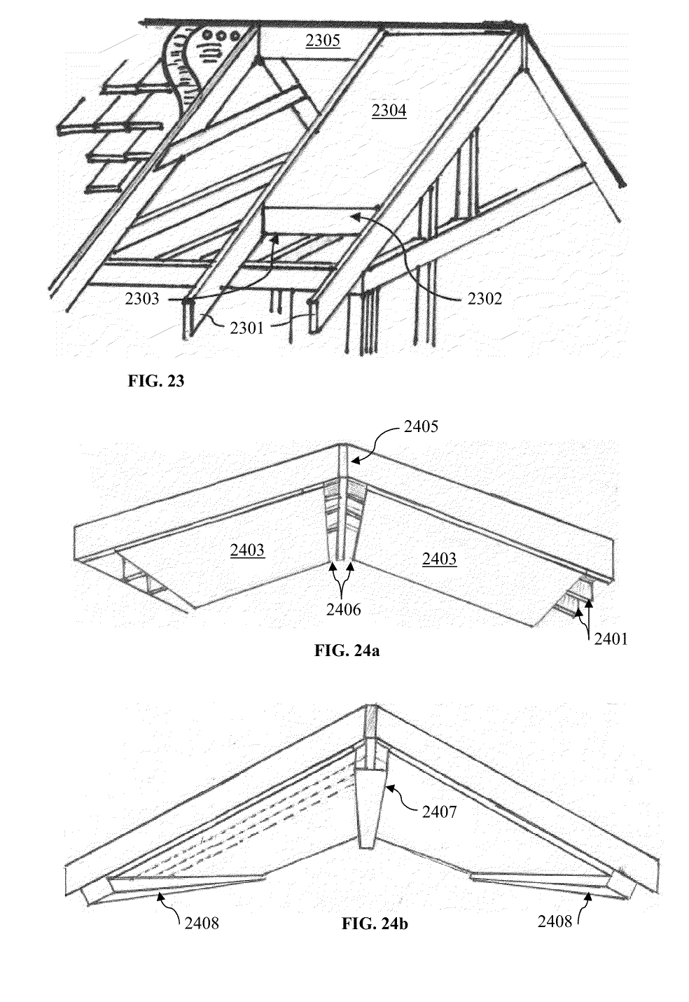

A principal embodiment of the invention is to enclose the space between the rafters 2301 (see FIG. 23) of a roof and converted them into longitudinally canals or conduit 2302. The canals follow the roof line and rise to the apex of the roof. The enclosure is achieved by affixing a panel 2403 (see FIG. 24a) across the bottom portion of the rafters 2401, resulting in a conduit or canal for the transport of warm air. The resultant enclosed space is bounded by the roof sheeting 2304 on the top side and the panel 2303/2403 on the bottom side and by the rafters 2301/2401 on each lateral side. The panels 2403 are preferably composed of a material that is rigid enough to cover the bottom portion of the rafters without sagging. In addition, it is preferred that the panels 2403 have a heat barrier component that is composed of an isolative material that will impede the heat from the conduit 2302 from transfer into the attic space.

Thus, when the rays from the sun heat the roof 2304, the heat from the roof then transfers into the canal system 2302 and warms the air between the rafters 2301. The heated air, within the canals 2302, rises by convection and is thus swept upward along the pitch of the roof towards the apex and ridge board 2305.

Again, the isolative panels 2403 are affixed and cover the lower portion of the rafters 2401. However, a space/opening 2406 of about 3 to 4 inches is left open before reaching the ridge board 2405 (See FIG. 24a). An encasing duct 2407 (FIG. 24b) is placed and affixed to the panels on each side of the ridge board, in that it runs parallel to the ridge board and perpendicular to the rafters. The encasing duct 2407 straddles the ridge board 2405 and both panels 2403 on each side of the ridge board as well as both openings 2406 between the ridge board and panels in that it allows air rising from between the rafters to enter the encasing duct. In this manner, the canals between the rafters act as tributary canals, for heated air, and the encasing duct 2407 acts as a collective mainstream duct. The openings 2406 are sufficiently large to allow air to flow from the tributary canals to the mainstream duct 2407.

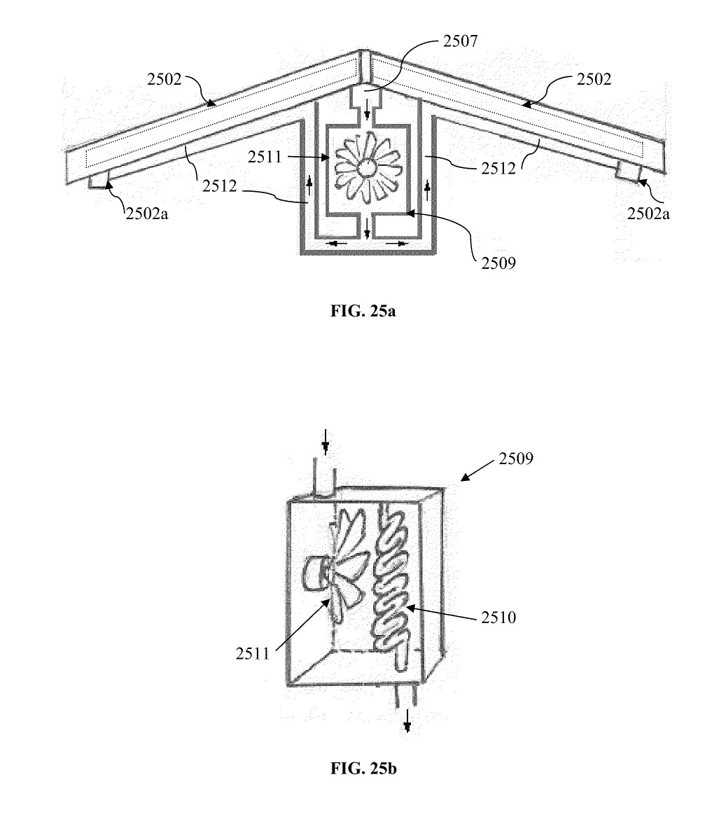

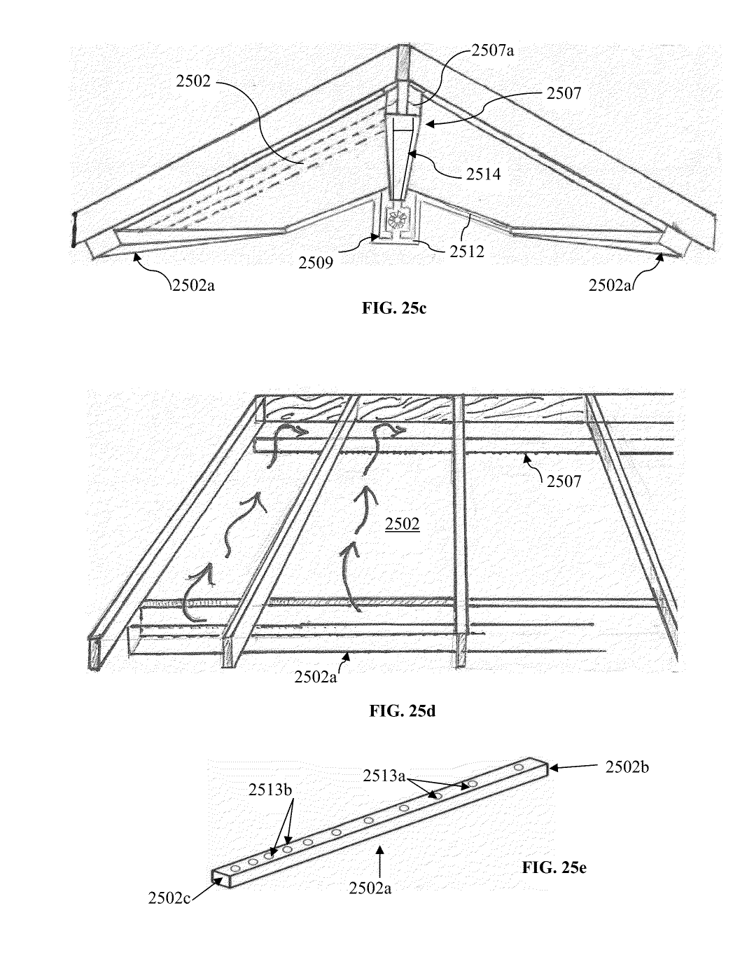

As the main stream duct collects heated air from the tributary canals, it transports it to one end of the ridge line and the heated/warm air is passed through an evaporator box 2509 (see FIGS. 25a and 25b), containing an evaporator 2510 and a fan 2511. Warm air from the mainstream duct 2507 is fanned by fan 2511 across the evaporator 2510 (i.e., second chamber of a mechanical leverage/advantage system, e.g., 1512 in FIG. 15), causing the refrigerant in the evaporator 2510 to boil. The boiling refrigerant absorbing heat from the warm air is used to power the mechanical advantage system, as earlier described. As the evaporator consumes the heat from the mainstream duct 2507, the temperature of the warm air passing the evaporator 2510 is lowered. Thus, the lower-temperature warm air needs to be recycled to be reheated as it will be explained below.

### Recycling the Air Exiting the Evaporator

Again, the warm air that has passed through the evaporator 2510 (see FIG. 25b) becomes cooler than the warm air that entered the evaporator box 2509 from the mainstream duct 2507 (see FIG. 25a). However, the air that has passed through the evaporator 2510 still contains useful residual heat and its temperature is usually still about 10-15 degrees F. higher than that of the outside air. Thus, rather than expelling this residual warm air to the outside, it would be economically more desirable to recycle the air by diverting it back from evaporator box 2509 into the tributary canals 2502, through recycling conduits 2512 and return duct/conduit 2502a, to be reheated again. Preferably, with the use of fans (not shown) and a duct/conduit system, the air passing through the evaporator 2510 may be rerouted back into the lower portion of the tributary canals 2502 via recycling conduits 2512 and return conduit 2502a (see FIGS. 25a and 25c).

The return conduit 2502a (see FIGS. 25a, 25c, 25d and 25e) is perforated (see 2513a-b in FIG. 25e) on the top surface releasing recycled air back into the tributary canals 2502. As shown in FIG. 25e, the perforations 2513b become gradually larger or closer together (or both) towards the distal end 2502c of the return conduit 2502a as it approaches the tributary canals furthest away from evaporator 2510. The perforations 2513a become gradually smaller or further spaced apart (or both) towards the proximal end 250b of the return conduit 2502a as it approaches the tributary canals that are closest to the evaporator 2510. In this respect, the smaller or further spaced perforations 2513a at the proximal end 2502b, release less amounts of air in the tributary canals that are positioned near the evaporator box 2509, thereby, slowing down the rate of air flow in the most proximal tributary canals, and thus, allowing more time for the air to be heated before reaching the mainstream duct 2507. As the return conduit 2502a reaches the furthermost tributary canals, the perforations become larger or closer together, or both, allowing greater quantities of air to exit and enter the tributary canals, hence there is a greater rate of flow of air into the tributary canals 2502. At the far end 2502c of the return conduit 2502a all the remaining air flows into the last tributary canal and ultimately into the mainstream duct 2507. The recycled air picks up heat from the inflow of the other tributary canals, as it travels through the mainstream duct 2507 back to the evaporator box 2509, and thus, to evaporator 2510. Additionally, the recycled air may be diverted to the return conduit 2502a that is most exposed to the sun by closing off the circulation of air (for example, at duct 2512) to the return conduit 2502a on the side that has less exposure to the sun.

Alternatively, the air may be rerouted back into the far/distal end 2507a (see FIG. 25c) of the mainstream duct 2507 via a conduit 2514 connecting the outlet of the evaporator box 2509 with the far/distal end 2507a through the shortest route possible (e.g., close to the apex of the roof) to avoid heat loss, and being optionally configured to communicate exclusively with the mainstream duct 2507 through recycling conduit 2512 and 2514, and not with the tributary canals 2502. It should be noted that, by introducing the recycled air into the lower portions of the tributary canals 2502, the time the recycled air can absorb heat from the roof is increased, and thus, the air becomes reheated well before it is passed through the evaporator again.

For purposes of illustration the roof sheathing has been removed in FIG. 25d. This illustration depicts the system described above for reheating air that has passed through the evaporator. Again, fans (not shown) force air through the return ducts 2502a into the tributary canals 2502 and back into the mainstream duct 2507.

Again, the enclosing bottom sections of the tributary canals system are comprised of panels 2403 (see FIG. 24a) that are preferably of manageable lengths and widths for easy assembly, and that attach and run longitudinally below and abutting the rafters 2401. More preferably, each panel of the canal system is pre-manufactured to dimensions that fit snugly on the bottom portion of the rafters enclosing the space between the rafters. In most cases, the rafters are spaced apart at 24 inches from rafters' center. Thus, the panels will preferably be 24 inches wide. The bottom portion of the panels may contain flanges or other means of affixing the panels with staples or nails to the bottom portion or sides of the rafters.

Again, the panels may be pre-manufactured at manageable lengths and widths to allow them to be cut and refitted end-to-end with the use of inserts. Cutting and rejoining the segments may achieve the desired lengths of the panels. As stated earlier, the panels are composed of a thermally insulative material, and preferably also of a fire retardant material.

It should be noted that the heat that would normally accumulate in the attic and ultimately penetrate the living space of a house is diverted into the evaporator box 2509 (FIGS. 25a-c) and absorbed by the evaporator 2510. Consequently, a great portion of the heat absorbed by the roof never has an opportunity to penetrate and heat the inside of the living space. In this regard, the work/energy required to cool the house is greatly diminished, and thus, this is another advantage of this heat collecting system. Furthermore, heat absorbed by the roof is normally unwanted and vented to the outside. However, utilizing this system, heat becomes useful and valuable; thus, the roof vents are preferably closed off.

If the goal was solely to cool the attic space, vents may be opened to allow warm air to escape and the compressor portion or any other load of the system may be disengaged or made nonexistent. In this instance, the second chamber (1512 in FIG. 15) will absorb heat from the attic or tributary canals and expel the heat to the outside via third chamber 1513. As the system continues to run, the temperature of the attic will tend to equilibrate and approximate the temperature of the outside until they become nearly equal.

The greater the mechanical advantage ratio of the system, the greater the volume of refrigerant gas that is displaced from second chamber 1512, and the cooler the air in the heat collecting system becomes. Consequently, the lower temperatures of the tributary canals increases the rate of heat absorption from the sun and ultimately a greater quantity of total heat is absorbed (hence energy) into the system. The roofing material preferably should have the properties that readily absorbs and conducts heat. Materials of dark colors or materials composed of metal or glass are quite suitable.

The heat collecting system is especially useful with vaulted ceilings where attic space is limited. The principle of heat collecting canals may also be integrated in roofing tiles. The tiles may be configured to interlock with one another and the canals within each tile may be aligned as to allow the flow of heated air from one tile to the other and ultimately to a mainstream duct placed close to the ridge board as described above.

Another application of the heat collecting system is its utilization with sun-exposed walls. In this application portholes or tubing are placed in the fire stops between the outside wall and the interior wall of the building. Heated air is drawn from between the walls and fed into the mainstream duct. Furthermore, the same principle may be applied to extract heat from within double paned windows or any other heat source.

Although specific embodiments have been illustrated and described herein for the purpose of disclosing the preferred embodiments, someone of ordinary skills in the art will easily detect alternate embodiments and /or equivalent variations, which may be capable of achieving the same results, and which may be substituted for the specific embodiments illustrated and described herein without departing from the scope of the present invention. Therefore, the scope of this application is intended to cover alternate embodiments and /or equivalent variations of the specific embodiments illustrated and/or described herein. Hence, the scope of the present invention is defined by the accompanying claims and their equivalents. Furthermore, each and every claim is incorporated as further disclosure into the specification and the claims are embodiment(s) of the present invention.

What is claimed is:

1. A mechanical leverage system comprising a first piston and cylinder assembly and a second piston and cylinder assembly and a first, a second and a third chamber, wherein, each chamber contains a fluid which is initially at predetermined and distinct pressure levels, and wherein, said first chamber comprises a first evaporator for absorbing heat from its surroundings so as to generate a gas-phase from a liquid-phase of the fluid, said second chamber comprises a second evaporator for absorbing heat from its surroundings so as to generate a gas-phase from a liquid-phase of the fluid and said third chamber comprises a condenser for expelling heat to its surroundings so as to convert a gas-phase of the fluid to a liquid-phase; wherein the second piston's cylinder is in controlled fluid communication with said second chamber and said third chamber such that the second piston acts as an expander for converting the thermal energy of the gas-phase fluid generated by said second evaporator into mechanical energy, and wherein the first piston's cylinder is in controlled fluid communication with said first chamber and said third chamber such that the first piston acts as a compressor for compressing the gas-phase fluid generated in said first chamber into said third chamber; wherein the second piston is coupled to the first piston so that the mechanical energy of the second piston is transmitted to the first piston, so that it drives the first piston, and wherein the second piston simultaneously displaces a greater volume of gas-phase fluid than the first piston so as to create a mechanical leverage; and, a pump for pushing liquid phase fluid from the third chamber to the second chamber and means for controllably releasing liquid phase fluid from the third chamber to the first chamber.

2. The mechanical leverage system of claim 1, wherein the pressure in the second chamber is greater than the pressure in the third chamber and the pressure in the third chamber is greater than the pressure in the first chamber.

3. The mechanical leverage system of claim 1 wherein the first evaporator is placed inside a building.

4. The mechanical leverage system of claim 1 wherein the condenser is placed outside a building.

5. The mechanical leverage system of claim 1 wherein the second evaporator is placed in the attic of a building so as to absorb the solar energy accumulated therein.

6. The mechanical leverage system of claim 1 further comprising a compressor applied between said second chamber and the second piston's cylinder, such that the energy of the system is augmented when necessary to compensate for the decrease in pressure in said second chamber below the predetermined pressure level.

7. The mechanical leverage system of claim 1 further comprising a compressor applied between said first chamber and the first piston's cylinder, such that the energy of the system is augmented when necessary to compensate for the decrease in pressure in said second chamber below the predetermined pressure level.

8. The mechanical leverage system of claim 1 further comprising a compressor applied between the first piston's cylinder and said third chamber, such that the energy of the system is augmented when necessary to compensate for the decrease in pressure in said second chamber below the predetermined pressure level.

9. The mechanical leverage system of claim 1 further comprising at least one member of a group consisting of a solenoid and a motor, and which is engaged onto the coupling between the second piston and the first piston, such that the energy of the system is augmented when necessary to compensate for the decrease in pressure in said second chamber below the predetermined pressure level.

10. The mechanical leverage system of claim 1, wherein the first chamber and the first piston are disengaged when there is a surplus of energy in the system and the second piston is leveraged and coupled to an electrical generator to harness the surplus of energy.

11. The mechanical leverage system of claim 1 wherein the first chamber and the first piston are disengaged and the second piston is leveraged and coupled to an air compressor such that the second piston drives the air compressor.

12. The mechanical leverage system of claim 11, further comprising at least one reservoir for storing the air compressed by the air compressor.

13. The mechanical leverage system of claim 1 wherein the first chamber and the first piston are disengaged and the second piston is leveraged and coupled to a compressor such that the second piston drives a heat pump.

14. The mechanical leverage system of claim 1, wherein the heat absorbed by the second evaporator is provided by a heat collecting system configured to collect and concentrate solar energy accumulated by the roof of a building, wherein said heat collecting system comprises: a plurality of canals positioned substantially parallel with the roof's slope such that the higher ends of the canals are in the proximity of the ridge board of the roof; a mainstream duct that collects hot air arriving through the higher ends of the canals; an evaporator box for housing said second evaporator and placed at one end of the mainstream duct; and a fan that pulls the hot air from the mainstream duct and pushes it onto said second evaporator.

15. The mechanical leverage system of claim 14, wherein the canals are positioned between the rafters of the roof and are thermally insulated on the bottom sections.

16. The mechanical leverage system of claim 1, wherein, the second evaporator absorbs heat from the engine of a vehicle, the first evaporator absorbs heat from at least one member of group consisting of the interior of the vehicle, the vehicle's refrigerator and the vehicle's freezer, and wherein, the condenser expels heat to the exterior of the vehicle.

17. A mechanical leverage system comprising a piston and cylinder assembly and a first, and a second chamber, wherein, each chamber contains a fluid which is initially at predetermined and distinct pressure levels and wherein the pressure of the fluid in said first chamber is greater than the pressure of the fluid in said second chamber, and wherein, said first chamber comprises an evaporator for absorbing heat from its surroundings, wherein the evaporator's surroundings comprise a member of a group consisting of the roof of a building and the engine of a vehicle, as to generate a gas-phase from a liquid-phase of the fluid; wherein, said second chamber comprises a condenser for expelling heat to its surroundings so as to convert a gas-phase of the fluid to a liquid-phase; wherein the piston's cylinder is in controlled fluid communication with the first and the second chamber such that said piston acts as an expander for converting the thermal energy of the gas-phase fluid generated by said evaporator into mechanical energy; and, a pump for pushing liquid phase fluid from said second chamber to said first chamber.

18. The mechanical leverage system of claim 17 wherein the evaporator absorbs heat from the engine of a vehicle, thus cooling the engine, and wherein the condenser expels heat to the exterior of the vehicle.

19. The mechanical leverage system of claim 17 wherein said mechanical energy is leveraged and used as an energy source for at least one member of a group consisting of a generator, a compressor for an air conditioner, an air compressor, and a heat pump.

20. A heat collecting system comprising: a plurality of canals positioned substantially parallel with a building roof's slope such that the higher ends of the canals are in the proximity of the ridge board of the roof; a mainstream duct that collects hot air arriving through the higher ends of the canals; an evaporator box for housing an evaporator and placed at one end of the mainstream duct; and a fan that pulls the hot air from the mainstream duct and pushes it onto said second evaporator.
